(19) United States
(12) Patent Application Publication
(10) Pub. No.: US 2003/0074248 A1
(43) Pub. Date: Apr. 17, 2003

(54) Method and system for assimilating data from disparate, ancillary systems onto an enterprise system

(76) Inventors: Kristopher P. Braud, Baton Rouge, LA (US); David Hastings, Baton Rouge, LA (US); Danny J. Ragan, Denham Springs, LA (US)

Correspondence Address: Rudolph J. Buchel, Jr., Jones, Day, Reavis & Pogue, 2727 North Harwood Street, P.O. Box 660623, Dallas, TX, 75266-0623, US

(21) Appl. No.: 09/822,013

(22) Filed: Mar. 31, 2001

(51) Int. Cl. G06F 17/60

(52) U.S. Cl. 705/9

(57) ABSTRACT

The present invention provides a means for an enterprise, such as a health care facility, to receive messages from any one of a plurality of disparate, ancillary vendor applications, convert the vendor information to an enterprise usable form and then store the enterprise information on an enterprise database. The enterprise keeps vendor specific rules for converting each vendor's information to enterprise information. Additionally, relational enterprise rules are applied to the enterprise data stored in a enterprise database, so as disparate vendor information is converted to enterprise data, the relationships between that converted enterprise data are checked with the enterprise data stored in the enterprise database. Enterprise data can also be directly entered into the enterprise database from enterprise system clients, the relationships between that enterprise data are also checked with the enterprise data stored in the enterprise database.

### BACKGROUND OF THE INVENTION

1. Field of the Invention

The present invention relates generally to information services systems and more particularly to assimilating and accessing data stored in disparate, ancillary systems. Still more particularly, the recent invention relates to the distribution and administration of medical services by presenting and/or accessing information at an enterprise level, which has been entered and stored in an ancillary system level. Still further, the present invention relates to intercepting communications between disparate systems wherein the communication is performed at an applications level.

2. Description of Related Art

A commercial enterprise, or enterprise, may be defined as a unit of economic organization or activity, especially a business organization for undertaking a project, especially a difficult, complicated or risky project. An enterprise may evolve in response to a need, which has been unfulfilled. Thus, the underlying goal of any enterprise is to successfully complete a common project or task. However, many commercial enterprises are compilations of enterprise departments that evolve to fulfill sub-tasks of the enterprise's primary task. These enterprise departments may originate autonomously from the enterprise to provide a solution for a task or instead, a department may be created internally by the enterprise for more effectively focusing on a particular sub-task. Independent enterprise departments may be acquired by an enterprise to supplement the enterprise's innate capacity. When properly integrated, the roles of individual enterprise departments are largely unrelated and dissimilar to other enterprise departments. The individual enterprise departments are supported by functional disparate systems.

One of ordinary skill in the art will understand that each of these enterprise departments may evolve its own particular infrastructure and culture. Individual enterprise departments most probably establish their own Information Systems Service (ISS) infrastructures based solely on their own information processing needs and budget constraints and without regard to the ISS needs of other enterprise departments. A department institutes its own information priori that shape its information system requirements. Individual enterprise departments establish relationships with hardware and software vendors based on that priori and set IS personal standards based on the vendor's products. As the role of the department changes within the enterprises, the department's vendors adjust their products accordingly, thus allowing the department to maintain or increase its market share in comparison to similar, but competing enterprise departments. Over the course of time, a department's vendor supplied applications become unique from other enterprise department's vendor supplied applications as each application provides ancillary functionality to all other department applications within the enterprise. In practice, the disparate, ancillary character of enterprise department applications and database structures is often beneficial to the enterprise because each department's applications are allowed to focus on the department's information priori with minimal interference from the enterprise of other department's information priori.

On the other hand, however, the information product of one department might be needed by another department for that department to expedite its enterprise sub-tasks. Therefore, a department needing another department's information product must either train its IS personnel on that department's applications or rely on that department to respond on request for its information product. Since enterprise departments relied on diverse vendor applications predicated on dissimilar information priori, information structures laced the coherence necessary for straightforward data exchange.

Problems, other than at the system level, also developed in the prior art. Enterprise department information products have an additional disadvantage of being system level data images. An enterprise level perspective of an information solution is difficult to achieve because it would be necessary for an enterprise user to understand the data images from all disparate, ancillary system's products that service the enterprise. Finding an enterprise level information solution is problematical because most enterprises rely on their enterprise departments for IS solutions thus, rarely does an enterprise establish an enterprise level information priori.

Aside from problems associated with hierarchical information levels, enterprise users needing to access system level data and functionality must be competent with a variety of disparate, ancillary applications. Any user needing data from a system must be competent with that system in order to utilize the disparate system interfaces for drilling down into individual department data structures. Many enterprise IS personnel are not overly proficient with a variety of disparate, ancillary applications and non-IS enterprise users are even less competent. Therefore, it is often left to the individual enterprise department to provide the necessary skilled IS personnel to interface with enterprise users needing system level data and functionality. Reliance on individual enterprise departments to access their disparate, ancillary systems for responding to enterprise user requests may result in a lag between the enterprise level query and a system level response from a department, as well as increasing the likelihood of a miscommunication between the enterprise user and a department's IS specialist. Maintaining a duplicative force of department IS personnel in each disparate, ancillary system to respond to enterprise users also increases the IS overhead for the disparate enterprise departments.

With respect to the health care services industry, the prior art attempts to solve many of the aforementioned shortcomings by eliminating the disparate, ancillary applications and application databases and utilizing an enterprise level application and application level database. By adopting an enterprise information priori, enterprise departments were forced to gradually migrate their ancillary applications toward the enterprise standard and gradually disband their legacy applications.

Of general background interest to the present invention are the following references. U.S. Pat. No. 5,867,821 issued to Ballantyne, et al. on Feb. 2, 1999 titled, “Method And Apparatus For Electronically Accessing And Distributing Personal Health Care Information And Services In Hospitals And Homes”. This reference describes a distribution and administration system that is interconnected to a master library (ML). The master library stores data in a digital compressed format through a local medical information network. The patient/medical personnel interact with this medical information network through a patient's individual electronic patient care station (PCS) that is interconnected to the master library PCS and receives the requested service or data from the master library. The requested data is then displayed either on the associated television set or video monitor or through wireless/IR communications to a peripheral personal data assistant (pen based computer technology). The data for text, audio and video information is all compressed digitally to facilitate distribution and only decompressed at the final stage before viewing/interaction.

In another example, U.S. Pat. No. 5,748,907 issued to Crane on May 5, 1998 titled, “Medical Facility And Business: Automatic Interactive Dynamic Real-Time Management” utilizes an Interactive Dynamic Real-Time Management System including a microprocessor adapted to sense the automatic interaction of real-time inputs. These real-time inputs relate to the method of controlling the position, flow of patients, employees, invoicing, appointment scheduling, and financial costs. With this automatic interactive management system, it also controls time, space and tasks routinely of a medical clinic or other types of businesses. A memory stores historical data related to the interaction of the real-time inputs and the microprocessor compares sensed real-time information with historical data to determine changes in unknown operating parameters. All information from real-time dynamic interacting, automatic, semiautomatic and manual inputs are fed into a master processor where the information is automatically sent to patients, employees, and other businesses in the network.

U.S. Pat. No. 6,055,506 issued to Frasca, Jr. on Apr. 25, 2000 titled, “Outpatient Care Data System” utilizes a plurality of metropolitan-area data systems operatively connected to a regional data system. Each of the metropolitan area data systems is located at a different metropolitan location and is dedicated to the transmission, storage and retrieval of outpatient data relating to the care of outpatients and is provided with a regional data system located at a regional location. Each metropolitan area data system may be provided with an electronic nursing station located within a hospital and first and second types of outpatient systems operatively coupled to the electronic nursing station on a real-time basis. A data storage system is located at a hospital which stores outpatient data in the form of a plurality of medical records for a plurality of outpatients associated with the outpatient care data system. For each outpatient, these medical records include an identification of the outpatient and data relating to the medical history of the outpatient.

In still another example of the prior art, U.S. Pat. No. 5,724,580 issued to Levin, et al. on Mar. 3, 1998 titled, “System And Method Of Generating Prognosis And Therapy Reports For Coronary Health Management” describes a system and method for automatically formulating an alpha-numeric comprehensive management and prognosis report at a centralized data management center for a patient at a remote location. Levin, et al. describes converting information regarding the condition of the patient into data, transferring the data to the centralized data management center and receiving the data. Then, generating the comprehensive management and prognosis report based on analysis of the data. A storage means is also provided at the centralized data management center for maintaining a record of the data received by and transmitted from the centralized data management center in a relational data base format.

In still another example, U.S. Pat. No. 5,301,105 issued to Cummings, Jr. on Apr. 5, 1994 tilted, “All Care Health Management System” describes a fully integrated and comprehensive health care system. That health care system includes integrated interconnection and interaction of the patient, health care provider, bank or other financial institution, insurance company, utilization reviewer and employer so as to include within a single system each of the essential participants to provide patients with complete and comprehensive pre-treatment, treatment and post-treatment health care and predetermined financial support therefor. A processing system(s) contains substantial memory storage capacity and the system employs such memory storage capacity to record a number of important bodies of data and other information. These data bodies may either be a part of the memory of the processing system or may be in other data banks that are accessible to the processing system.

Finally, U.S. Pat. No. 6,112,183 issued to Swanson, et al. on Aug. 29, 2000 titled, “Method And Apparatus For Processing Health Care Transactions Through A Common Interface In A Distributed Computing Environment” describes an apparatus and method for processing health care transactions through a common interface in a distributed computing environment using specialized remote procedure calls. The distributed computing environment includes a user interface tier for collecting user inputs and presenting transaction outputs, a data access tier for data storage and retrieval of health care transaction information, a transaction logic tier for applying a predetermined set of transaction procedures to user inputs and health care transaction information resulting in transaction output, an electronic network connecting the user interface tier, data access tier and transaction logic tier to each other and a communication interface for exchanging health care transaction information among the tiers. The communication interface includes an interface definition language generating transaction-specific communication codes whereby data is exchanged through a common interface structure regardless of the origin of the data.

### SUMMARY OF THE INVENTION

The present invention provides a means for an enterprise, such as a health care facility, to receive messages from any one of a plurality of disparate, ancillary vendor applications, convert the vendor information to an enterprise usable form and then store the enterprise information on an enterprise database. The enterprise keeps vendor specific rules for converting each vendor's information to enterprise information. Additionally, relational enterprise rules are applied to the enterprise data stored in a enterprise database so as disparate vendor information is converted to enterprise data, the relationships between that converted enterprise data are checked with the enterprise data stored in the enterprise database. Enterprise data can also be directly entered into the enterprise database from enterprise system clients. The relationships between that enterprise data are also checked with the enterprise data stored in the enterprise database.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 is a diagram of an exemplary HL7 message;

FIG. 2 is a network diagram showing several disparate, ancillary systems depicted as Admissions, Discharge and Transfers (ADT), Radiology, Medical Records/Transcriptions, Pharmacy and Laboratory;

FIG. 3 is a flowchart depicting a process by which a disparate, ancillary system generates a message in response to a trigger event;

FIG. 4 is a diagram of an enterprise network, which utilizes an automated interface gateway for routing level seven (such as HL7) event triggered messages;

FIG. 5 is a diagram of an enterprise system which includes a plurality of disparate, ancillary systems for executing enterprise level message transactions in accordance with an exemplary embodiment of the present invention;

FIG. 6 is an illustration of patient census information for Dr. Ralph Shyner, from the example used above;

FIG. 7 is an illustration of lab results displayed on Dr. Shyner's web page as a result of the doctor selecting the “Laboratory Results” command in menu box 616 of FIG. 6 in accordance with an exemplary embodiment of the present invention;

FIG. 8 is a flowchart depicting a process employed by the Automated Interface Gateway (AIG) catcher for converting system level messages consisting of vendor-specific, system level segment and segment data fields into enterprise level message data in accordance with an exemplary embodiment of the present invention

FIGS. 9A to 9C depict flowcharts, which depict message transaction processing performed by the enterprise server in accordance with an exemplary embodiment of the present invention;

FIG. 10, a flowchart depicting an exemplary process for privilege checking, is shown that may be performed by an enterprise application in accordance with an exemplary embodiment of the present invention;

FIG. 11, a flowchart depicting the process by which an enterprise application processes a transaction request, is illustrated in accordance with an exemplary embodiment of the present invention;

FIG. 12 is a flowchart depicting a process for manually creating a request query to a disparate, ancillary system for system level event data that corresponds to corrupted enterprise data on the enterprise database in accordance with an exemplary embodiment of the present invention; and

FIG. 13 is a flowchart depicting a process for restoring enterprise data on the enterprise database from one or more of the disparate, ancillary systems' databases in accordance with an exemplary embodiment of the present invention.

Other features of the present invention will be apparent from the accompanying drawings and from the detailed description that follows.

### DETAILED DESCRIPTION OF THE INVENTION

Migrating to an enterprise level system from a plurality of disparate, ancillary systems is an expensive and time consuming undertaking for an enterprise. Many enterprises refuse to move from antiquated legacy systems to more modem, user friendly managed desktops such as network computing (NC), or the like, until the Total Cost of Ownership (TCO) for maintenance and upkeep on the legacy system exceeds that of TCO for implementing the more modern network. In the case of disparate, ancillary system applications, the TCO factors are even less appealing to the enterprise because oftentimes, the ancillary applications are state of the art, though not enterprise friendly. Additionally, instituting enterprise level infrastructures, including master libraries and data stores, is a daunting task for an enterprise because department IS specialists must be retrained for the enterprise technology. In an effort to alleviate many of the shortcomings described above, standardized message protocols have been promulgated for the transfer of messages between individual disparate, ancillary systems, rather than wholesale migration to enterprise level systems. By adopting standardized messaging protocols and without resorting to expensive enterprise-wide solutions, disparate, ancillary system applications can communicate more effectively and thus, alleviate at least a portion of the limitation of the prior art.

Many of these standardized message protocols utilize the seventh, or top layer, of the protocol stacks known as the Application Layer. Application Layer Seven is the top layer of the many protocol stacks, including the OSI (Open System Interconnection) and TCP/IP (Transmission Control Protocol/Internet Protocol) protocol suites. Generally, an application layer is software that provides the starting point for a communications session. Software programs in the application layer initiate communications between entities, such as applications.

Some of the most widely known application protocols in the TCP/IP suite are FTP (File Transfer Protocol), SMTP (Simple Mail Transfer Protocol), Telnet, DNS (Domain Name System) and WINS (Windows Internet Name System). Other, more special purpose application level protocols also exist. These include the IN (Intelligent Network) and AIN (Advanced Intelligent Network) protocols of the SS7 (Signaling System 7) protocol used in publicly switched telephone systems and the HL7 (Health Level Seven) protocol used in the healthcare industry. With the exception of certain of the TCP/IP's own application protocols, the language and format used in a user's client/server program are not known to a transport or communications protocol and instead, they are known only to the receiving programs that must parse the incoming request to find out what the client is asking for. In many instances, data from the programs at the top layer of a protocol suite are “handed down” to the lower layers in a protocol stack for actual transport processing. Conversely, the data is then “handed up” the protocol stack to the appropriate application in the receiving machine.

With respect to the TCP/IP protocol suite, a program identifies the application it wishes to communicate with by that application's socket (also referred to as a socket address or socket number), which is a combination of (1) the server's IP address and (2) the application's port. If, using the TCP/IP protocol for example, an application does not know the IP address of the destination application, but knows the server by name, the application uses a Domain Name System server (DNS server) to turn the name into the IP address. The port is a logical number assigned to every application. For FTP, SMTP, HTTP and other common applications, there are agreed-upon numbers known as “well-known ports.” For example, HTTP applications (world wide web) are on port 80 therefore, a web server is located by its IP address and port 80. An organization's internal client/server applications are given arbitrary ports for its own purposes.

Generally, protocols are standardized by industry members (application developers, OEMs (Original Equipment Manufacturer) and interested parties, together herein referred to as “vendors”). These vendors form a common interest standards organization that works for harmonizing rules for using the subject protocol. The primary purpose of a standards organization is to attempt to adopt metrics and rules for the use of hardware or software. The rules are sometimes referred to as the specification and using a specification adopted by a standards body is referred to as a dejure use (as opposed to defacto use where the specification is informally adopted by its wide acceptance and use without formal sanctioning). Exemplary standards bodies include ANSI, (American National Standards Institute) and ISO, (The International Organization for Standardization). Rules for application level protocols include language and format standards needed to establish a session. Applications that follow the particular rules established by a standards body are considered compliant with the standard they follow. In the case of an applications layer protocol, it is expected that two compliant applications would be able to establish a communications session because the language and format of the session has been harmonized in advance by the standards body for the application level protocol.

In practice however, the rules set forth by a standards body can be rather loose and may take the form of guidelines rather than rigid rules. Usually loose standards are an outcome of competing marketplace interests, where each vendor jealously supports protocol rules compatible with its own product rather than supporting rules that favor another vendor's products. In its infancy, the standards body often attempted to pacify competing interests within the standards body by adopting looser rules which did not give any individual or group of vendors a strategic advantage in the marketplace. Rather than alienating any major players in the body by adopting standardization rules similar to a competing vendor's product, the standards body also gave individual vendors more discretion to use their own proprietary protocol variants.

Lax, flexible or conflicting standardization rules may result in applications that are compliant with the standard and yet, unable to decipher each other's message structures and/or data definitions. In the case of application layer protocols, the resulting inadequacies may be as severe as the inability of compliant applications to establish a session or as minor as an application not being able to decipher proprietary segments of a message sent from another application.

With regard to the discussion herewithin, a level seven message will be understood by artisans as the atomic unit of data transferred between disparate system applications. Every message is structured as a group of segments in a defined sequence. Most messages are triggered by real world events and every message type defines the purpose of the message. For example, a patient being admitted to a health care enterprise triggers an ADT Message type A01. Below, Table I is a nonexhaustive list containing exemplary HL7 message types and descriptions of the message.

TABLE I
(HL7 Message Types)

| Message | Description |
|---|---|
| ACK | General acknowledgment message |
| ADR | ADT response |
| ADT | ADT message |
| DOC | Document response |
| PIN | Patient insurance information |
| R0R | Pharmacy/treatment order response |
| RAR | Pharmacy/treatment administration information |
| RAS | Pharmacy/treatment administration message |
| RDO | Pharmacy/treatment order message |
| RDR | Pharmacy/treatment dispense information |
| RDS | Pharmacy/treatment dispense message |
| SQM | Schedule query message |
| SQR | Schedule query response |
| SRM | Schedule request message |
| SRR | Scheduled request response |
| SUR | Summary product experience report |
| TBR | Tabular data response |

The ADT type A01 message is from Patient Administration (ADT) triggered by an event (A01) concerning a patient being admitted. The patient admission trigger event causes the ADT application to broadcast the ADT type A01 message to a predefined set of application socket addresses. The message body contains pertinent data describing the event. For the purposes of the description of the present invention, the exemplary discussions will refer to the HL7 messaging protocol adopted by the healthcare industry. The use of the HL7 standard is not meant to limit the scope or use of the present invention and, as ordinary artisans will readily realize, the present invention may be implemented in a variety of protocols adopted by various business enterprises without departing from the scope or intent of the present invention.

HL 7 messages are composed of uniquely identified segments and each uniquely identified message segment is a logical grouping of segment fields. Below, Table II is a nonexhaustive list containing exemplary HL7 segment types and corresponding segment descriptions.

TABLE II
(HL7 Segment Types)

| Segment | Description |
|---|---|
| ACC | Accident segment |
| ADD | Addendum segment |
| AIG | Appointment information - general resource segment |
| AIL | Appointment information - location resource segment |
| AIP | Appointment information - personnel resource segment |
| AIS | Appointment information - service segment |
| AL1 | Patient allergy information segment |
| APR | Appointment preferences segment |
| ARQ | Appointment request segment |
| AUT | Authorization information segment |
| BLG | Billing segment |
| ERR | Error segment |
| EVN | Event type segment |
| FAC | Facility segment |
| FHS | File header segment |
| FT1 | Financial transaction segment |
| LCC | Location charge code segment |
| LCH | Location characteristic segment |
| LDP | Location department segment |
| LOC | Location identification segment |
| LRL | Location relationship segment |
| MFI | Master file identification segment |
| MSA | Message acknowledgment segment |
| MSH | Message header segment |
| PID | Patient identification segment |
| RXA | Pharmacy/treatment administration segment |
| RXC | Pharmacy/treatment component order segment |
| RXD | Pharmacy/treatment dispense segment |
| RXE | Pharmacy/treatment encoded order segment |
| RXG | Pharmacy/treatment give segment |
| RXO | Pharmacy/treatment order segment |
| RXR | Pharmacy/treatment route segment |

Every segment field is associated with a particular data element type and that association depends on the type of unique segment containing the segment field. Below, Table III is a nonexhaustive list containing exemplary HL7 data element types and corresponding specification for the data elements.

TABLE III
(HL7 Data Element Types)

| Element Type/Description | Item# | Seg | Seq# | Len | DT | Rep | Table |
|---|---|---|---|---|---|---|---|
| Accident Code | 00528 | ACC | 2 | 60 | CE | | 0050 |
| Accident Date/Time | 00527 | ACC | 1 | 26 | TS | | |
| Accident Death Indicator | 00814 | ACC | 6 | 12 | ID | | 0136 |
| Accident Job Related Indicator | 00813 | ACC | 5 | 1 | ID | | 0136 |
| Accident Location | 00529 | ACC | 3 | 25 | ST | | |
| Account ID | 00236 | BLG | 3 | 100 | CX | | |
| Account Status | 00171 | PV1 | 41 | 2 | IS | | 0117 |
| Acknowledgment Code | 00018 | MSA | 1 | 2 | ID | | 0008 |
| Admission Type | 00134 | PV1 | 4 | 2 | IS | | 0007 |
| Admit Date/Time | 00174 | PV1 | 44 | 26 | TS | | |
| Admit Reason | 00183 | PV2 | 3 | 60 | CE | | |
| Admit Source | 00144 | PV1 | 14 | 3 | IS | | 0023 |
| Admitting Doctor | 00147 | PV1 | 17 | 60 | XCN | Y | 0010 |
| Assigned Patient Location | 00133 | PV1 | 3 | 80 | PL | | |
| Assigned Patient Location | 00133 | FT1 | 16 | 80 | PL | | |
| Attending Doctor | 00137 | PV1 | 7 | 60 | XCN | Y | 0010 |
| Billing Category | 01007 | PRC | 14 | 60 | CE | Y | 0293 |
| Birth Order | 00128 | PID | 25 | 2 | NM | | |
| Birth Place | 00126 | PID | 23 | 60 | ST | | |
| Business Phone Number | 00195 | NK1 | 6 | 40 | XTN | Y | |
| Consulting Doctor | 00139 | PV1 | 9 | 60 | XCN | Y | 0010 |
| Contact Address | 01166 | FAC | 7 | 200 | XAD | Y | |
| Contact Person | 01266 | FAC | 5 | 60 | XCN | Y | |
| Contact Person Social Security | 00754 | NK1 | 37 | 16 | ST | | |
| Number | | | | | | | |
| Contact Person's Address | 00750 | NK1 | 32 | 106 | XAD | Y | |
| Contact Person's Name | 00748 | NK1 | 30 | 48 | XPN | Y | |
| Contact Person's Name | 00748 | GT1 | 45 | 48 | XPN | Y | |
| Contact Person's Telephone Number | 00749 | NK1 | 31 | 40 | XTN | Y | |

The first column of Table III identifies a data element by ELEMENT TYPE while the remaining columns define the element's HL7 attributes. ITEM # is an HL7-specific number that uniquely identifies the data element throughout the HL7 standard. SEG is the HL7 identity of any segments that the data element will occur and SEQ defines the ordinal position of the data element within the identified HL7 segment. The column labeled LEN refers to the maximum number of characters that one occurrence of the data element may occupy within the segment. The length of a field is normative; however, in general practice, it is often negotiated on a vendor-specific basis. The column labeled DT refers to restrictions on the contents of the data field. REP defines whether a field may repeat and if so, the maximum number of repetitions permitted. The column labeled TABLE defines a HL7 table of values for a particular data element. A table defines a list of values for the entity. In this case, the data element. Tables may contain either HL7 or user defined values.

Segment types may be required or optional, depending on the message and event types. Segments are identified using a unique segment identifier code (ID). For example, an ADT message may contain Message Header (MSH), Event Type (EVN), Patient ID (PID), and Patient Visit (PV1) segments. Segments may also be proprietary to a vendor and thus identified with segment ID codes beginning with the letter Z.

Each HL7 segment consists of a collection of segment fields, or string of characters. Certain segment fields may be required or merely optional within a particular segment depending on the segment identifier code. Segment fields are transmitted as character strings; however, some HL7 segment fields may take on the null value, which is different from an optionally deleted field. For cases where a value for the data element is transmitted, a segment field may contain a data element or might merely be a placeholder within the segment for that data element. The HL7 Standard specification contains segment attribute tables that list and describe data fields within an identified segment and characteristics of their usage. HL7 fields are defined in a comprehensive data field dictionary.

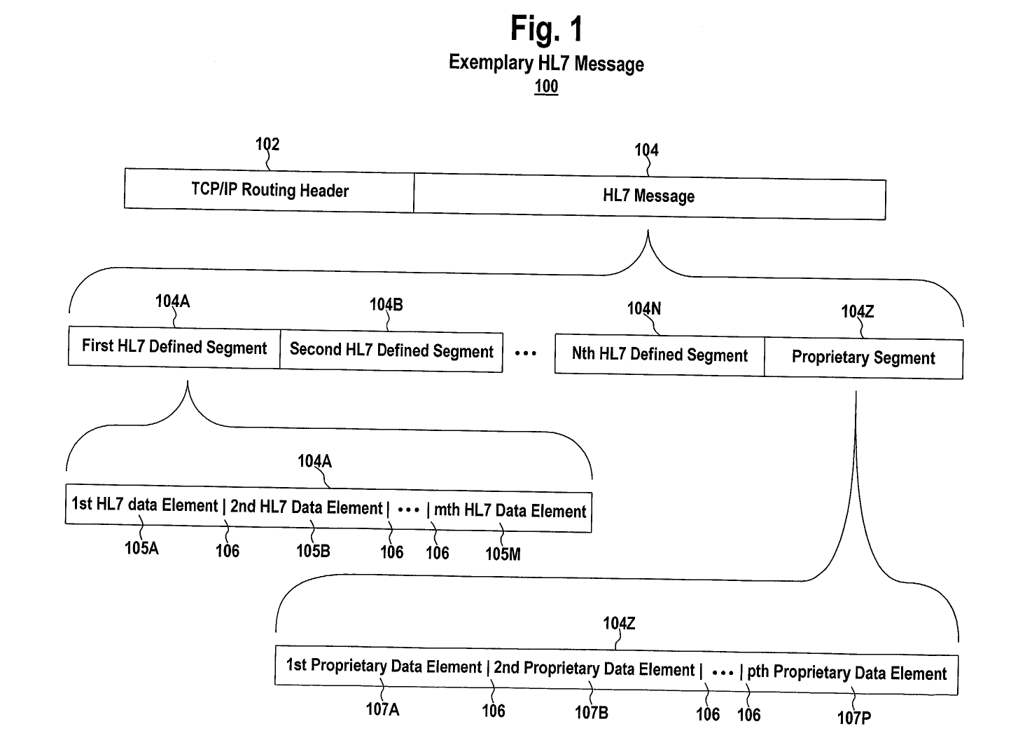

FIG. 1 is a diagram of an exemplary HL7 message 100. A HL7 message is normally generated in response to a trigger event. There are various message types defined in the HL7 message specification for various trigger events. Each message type comprises of segments which, in turn, are built up by different segment fields. The inclusion of the fields in the message segment may be Required (R), Optional (O), or Not Used (N). Below are some exemplary HL7 message types, along with segment descriptions for each message.

1. Message Type: ACK (General Acknowledgement Originator)—It has 3 segments:

(a) MSH—Message Header (R).

(b) MSA—Message Acknowledgement (R).

(c) ERR—Error Message

2. Message Type: ADT (Admission, Discharge and Transfer)—It has various ADT events associated. For example,

ADT Event Code: A01

Event: ADMIT A PATIENT

Message Segments are:

(a) MSH—Message Header (R).

(b) EVN—Event Type (R).

(c) PID—Patient Identification (R).

(d) NK1—Next of Kin (R).

(e) PV1—Patient Visit (R).

(f) DG1—Diagnosis Information (O).

ADT Event Code: A02

Event: TRANSFER A PATIENT

Message Segments are:

(a) MSH—Message Header (R).

(b) EVN—Event Type (R).

(c) PID—Patient Identification (R).

(d) PV1—Patient Visit (R).

ADT Event Code: A03

Event: DISCHARGE A PATIENT

Message Segments are:

(a) MSH—Message Header (R).

(b) EVN—Event Type (R).

(c) PID—Patient Identification (R).

(d) PV1—Patient Visit (R).

The PID (Patient Identification) segment is used by all ancillary systems' applications as the primary means of communicating patient identification information. This segment contains permanent patient identifying and demographic information that, for the most part, is not likely to change frequently. Therefore, the PID segment must contain non-ambiguous information values that are easily understood across disparate systems. Below is an exemplary table containing segment attributes for a PID segment.

TABLE IV
(PID Segment Attributes)

| Seq | Len | DT | Opt | Rep | Table | Item# | Element Type |
|---|---|---|---|---|---|---|---|
| 1 | 4 | SI | O | | | 00104 | Set ID - PID |
| 2 | 20 | CX | B | | | 00105 | Patient ID |
| 3 | 20 | CX | R | Y | | 00106 | Patient Identifier List |
| 4 | 20 | CX | B | Y | | 00107 | Alternate Patient ID - PID |
| 5 | 48 | XPN | R | Y | | 00108 | Patient Name |
| 6 | 48 | XPN | O | Y | | 00109 | Mother's Maiden Name |
| 7 | 26 | TS | O | | | 00110 | Date/Time of Birth |
| 8 | 1 | IS | O | | 0001 | 00111 | Sex |
| 9 | 48 | XPN | O | Y | | 00112 | Patient Alias |
| 10 | 80 | CE | O | Y | 0005 | 00113 | Race |
| 11 | 106 | XAD | O | Y | | 00114 | Patient Address |
| 12 | 4 | IS | B | | 0289 | 00115 | County Code |
| 13 | 40 | XTN | O | Y | | 00116 | Phone Number - Home |
| 14 | 40 | XTN | O | Y | | 00117 | Phone Number - Business |
| 15 | 60 | CE | O | | 0296 | 00118 | Primary Language |
| 16 | 80 | CE | O | | 0002 | 00119 | Marital Status |
| 17 | 80 | CE | O | | 0006 | 00120 | Religion |
| 18 | 20 | CX | O | | | 00121 | Patient Account Number |
| 19 | 16 | ST | B | | | 00122 | SSN Number - Patient |
| 20 | 25 | DLN | O | | | 00123 | Driver's License Number - Patient |
| 21 | 20 | CX | O | Y | | 00124 | Mother's Identifier |
| 22 | 80 | CE | O | Y | 0189 | 00125 | Ethnic Group |
| 23 | 60 | ST | O | | | 00126 | Birth Place |
| 24 | 1 | ID | O | | 0136 | 00127 | Multiple Birth Indicator |
| 25 | 2 | NM | O | | | 00128 | Birth Order |
| 26 | 80 | CE | O | Y | 0171 | 00129 | Citizenship |
| 27 | 60 | CE | O | | 0172 | 00130 | Veterans Military Status |
| 28 | 80 | CE | O | | 0212 | 00739 | Nationality |
| 29 | 26 | TS | O | | | 00740 | Patient Death Date and |
| | | | | | | | Time |
| 30 | 1 | ID | O | | 0136 | 00741 | Patient Death Indicator |

The PID Segment Attribute Table IV is similar to Table III (HL7 Data Element Types) described above with the additional column labeled OPT that defines whether or not a particular field is required (R), optional (O), conditional in a segment (C), not used with a trigger event (X) or left in for backward compatibility for other HL7 versions (B). Using the above-described HL7 rules, any disparate application can generate an HL7 message. Below is an example of an HL7 admit/visit notification transaction triggered from an A01 event (admitted patient).

MSH|\hat{ }˜\&|ADT1|SWR|LABADT|SWR|198808181126|SECURITY|
ADT\hat{ }A01|MSG00001|P|2.3.1|<cr>
EVN|A01|200101030803||<cr>
PID|1||PATID1234\hat{ }5\hat{ }M11\hat{ }ADT1\hat{ }MR\hat{ }SWR˜123456789\hat{ }\hat{ }\hat{ }USSSA\hat{ }
SS||JOHNSON\hat{ }DARRELL\hat{ }A||19610615|M||C|1200 N ELM
STREET\hat{ }\hat{ }GREENSBORO\hat{ }NC\hat{ }27401-1020|GL|(919)379-1212|(919)
271-3434||S||
PATID12345001\hat{ }2\hat{ }M10\hat{ }ADT1\hat{ }AN\hat{ }A|123456789|987654\hat{ }NC|<cr>
NK1|1|JONES\hat{ }BARBARA\hat{ }K|WI\hat{ }WIFE||||NK\hat{ }NEXT OF KIN<cr>
PV1|1|I|7050\hat{ }7113\hat{ }01||||101010\hat{ }SHYNER\hat{ }RALPH\hat{ }J.|||SUR||||ADM|
A0|<cr>

Patient Darrel A. Johnson was admitted on Jan. 03, 2001 at 08:03 a.m. by doctor Ralph J. Shyner (#101010) for surgery (SUR). He has been assigned to room 7113, bed 01 on nursing unit 7050. The message was sent from system ADT1 at the SWR site to system LABADT, also at the SWR site, on the same date as the admission took place, but three minutes after the admit.

Returning to FIG. 1, HL7 message 100 is composed of at least two parts, TCP/IP routing header 102 and HL7 message 104. The structure of TCP/IP routing header 102 is well known and will not be discussed further except to note that TCP/IP routing header 102 contains routing information necessary to transmit message 100 from a source application to a destination application. The sources and destination are both identified in packet 100's header.

HL7 message 104, on the other hand, is defined by rules set forth in the HL7 specification and those rules must be observed for a message generated by one disparate, ancillary system to be understood by a second disparate, ancillary system. In general, HL7 message 104 is comprised of a series of uniquely identified message segments which serve a purpose according to the message type, segments 104A-104N and 104Z are shown in FIG. 1. Segments 104A-104N contain information arranged and formatted in accordance with HL7 segment attribute rules. Each of the N segments contains a predetermined number for segment fields for holding a sequence of HL7 defined data elements.

Proprietary segment 104Z differs from HL7 defined segments 104A-104N in that the data element values contained within segment 104Z may be vendor-specific. This data may be defined and implemented by individual application vendors without regard to the HL7 specification. Often, vendors will utilize proprietary segments when the standardized definitions are ambiguous or significant errors have been encountered by attempting to follow message protocol standards. As discussed above, proprietary segment 104Z is uniquely identified as such and may be disregarded by disparate systems which are not privy to the vendor's proprietary segment specification.

Within each of the segments 104A-104N and 104Z, are a series of defined data elements. Segment 104A is shown as having M number of HL7 defined data elements in fields 105A-105M. Each of the fields 105A-105M is delimited by field separator 106 (although not shown in FIG. 1 segment boundaries are also delimited by segment terminators). Each data element occupies a predefined segment field that is defined by field delimiters. Therefore, by utilizing the HL7 definition for a particular segment type, the segment field associated with a particular data element may be found in HL7 message 100 using a three-step process. First, it identifies the message type and derives the segment and element types for that message. Next, it identifies a segment containing the value of a data element. Finally, it finds the segment field that holds the data element by counting delimiters.

Proprietary segment 104P may also be comprised of a series of data items separated by delimiters. FIG. 1 depicts proprietary segment 104Z as having words 107A-107P, each word separated with the segment by delimiters 106. However, in contrast with HL7 defined segments 104A-104N, proprietary segment 104Z may consist of P vender-defined proprietary words 107A-107P that are arranged within proprietary segment 104Z according to a vendor-defined specification. Therefore, even if the element type definitions of data element 107A-107P comply with the HL7 protocol, accessing the values for these elements in a message is nearly impossible without using the vendor's specification that defines the segment fields that hold each data element.

Generally, it is expected that each of the segments 104A-104N contain uniquely defined data elements, arranged in a predetermined sequence. Therefore, in any HL7 compliant message, it should be possible to identify where the segment data element resides without reading every data element in each segment. Thus, a receiving application can expedite the retrieval and essential data value by merely accessing the particular segment in message 100 that holds the essential data element. By merely counting field separators, the application can forgo reading any data value located in segment fields that are not essential to the message. Conversely, a sending application may omit entering data element values in any segment field that the application does not consider essential to the message. However, as alluded to above, data type definitions are often ambiguous, making the association between a particular data type and a particular data field and segment less sure and more dependent on vendor specifications.

Yet another issue is when you receive a standard HL7 revision record. As an example, the patient Darrel Johnson is moved from bed 01 on nursing unit 7050 to bed 04 in nursing unit 6050. Some vendors will send a complete HL7 revision record with all patient data including the new room and bed data. Yet another vendor will send only the “change” data elements and omit the “unchanged” elements. Since the record received for processing is, by definition, a “revision” record, one has to wonder if the omitted data elements infer that the omitted data element should be “blanked out”, deleted or “nulled” in the enterprise database. Depending on the vendor, some blank data elements in the received HL7 revision record should be ignored and the enterprise database should retain any previous data elements. In yet another vendor's revision record processing, the blank data field will signify that the original data entry person(s) intended to “remove” ambiguous data from the enterprise database and should therefore be processed in the enterprise database accordingly. Here, applying the vendor supplied processing rules to incoming HL7 records becomes very important to the integrity of the enterprise database.

Fundamental to the success of any standard messaging protocol is the ability for disparate, ancillary systems to understand message content generated by and received from other systems. Messaging protocols must standardize data elements and attribute definitions by providing unambiguous definitions for every data element and attribute. Definitions that are too broad breed confusion in a message body as vendors will invariably use different entry fields for identical data values. When implementing a messaging protocol, care must be taken to avoid confusion between vendors of disparate, ancillary system applications. Initially, vendors must agree to a standardized protocol. Once the protocol has been decided, an auxiliary specification must be established between vendors that specify additional trigger events and message types that identify optional values to be used within the protocol's specification and clarifies perceived ambiguities between vendors.

With regard to prior art medical ISS technologies, individual medical departments contracted for, and implemented their own ISS solutions without regard to the needs of the enterprise as a whole or the needs of other departments within the enterprise. ISS integration and compatibility was not a concern. Data entry, information storage and data retrieval was performed by the individual departments. However, an individual user had to be authorized on the disparate, ancillary application systems and use application interfaces from the individual applications. The individual applications did not interface with each other unless the applications were products by the same vendor.

The result, for whatever reason, is an industry supported by multiple vendors, each sponsoring its own ancillary system applications, which are incorporated in an enterprise's ISS. From an enterprise level perspective, most ISS assimilation appears to be on an ad hoc basis. More importantly, due to the ad hoc assimilation and structuring of ISS systems, it is impossible for a user to get a coherent view of enterprise level data from the ancillary systems. A user needing data, most generally, must be authorized by an ancillary department and then access the disparate, ancillary system that is responsible for acquiring that particular data for that department. With such a system in place, it is virtually impossible for a user to understand enterprise relationships between the data stored in disparate, ancillary systems. Still more exacerbating, a user must gain a certain amount of proficiency in every system in order to effectively drill down into an ancillary database to needed data. It is utterly impossible for a non-ISS user, such as a manager, engineer, nurse, doctor, specialist, etc., to gain that level of proficiency in the normal course of business.

After several departments obtain their needed ISS systems, those departments soon realize the need to communicate with each other. If, by chance, the vendor applications are compatible or compliant with a standard, the disparate, ancillary application may communicate. If, as is more likely, the disparate vendor applications are not compatible or not compliant or the standards are weak, then the disparate applications may not communicate in a meaningful way.

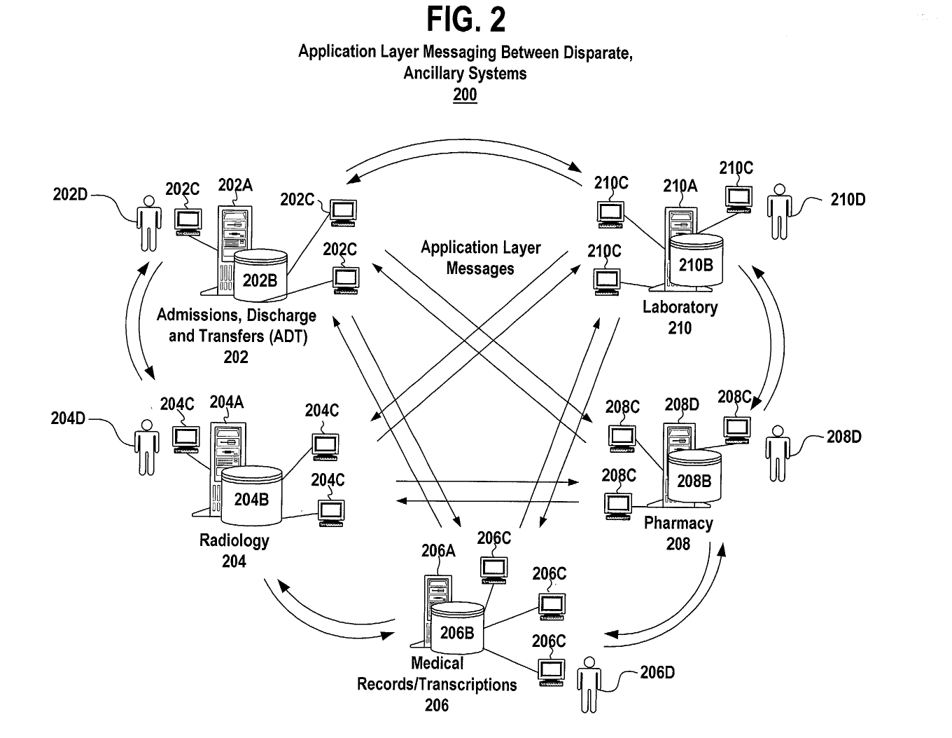

Communication between ancillary systems may take a number of forms, but for the purpose herein, the communications process occurs as depicted in FIG. 2. FIG. 2 shows several disparate, ancillary systems depicted as Admissions, Discharge and Transfers (ADT) 202, Radiology 204, Medical records/transcriptions 206, Pharmacy 208 and Laboratory 210. The depicted systems are merely illustrative of the disparate, ancillary systems that may be present within a health care enterprise and one of ordinary skill in the art would readily realize that other systems may be present in combination or in place of the exemplary systems. Each of the respective disparate, ancillary systems utilize servers 202A, 204A, 206A, 208A and 210A for processing information to and from their respective terminals 202C, 204C, 206C, 208C and 210C and storage units 202B, 204B, 206B, 208B and 210B. It is expected that any one users 202D, 204D, 206D, 208D and 210D initiate a trigger event by communicating with their respective servers 202A, 204A, 206A, 208A and 210A via respective terminals 202C, 204C, 206C, 208C and 210C.

The occurrence of the real world event triggers a message, in this case a HL7 compliant message, being sent. Message transactions are represented by arrows to and from each of the disparate, ancillary systems 202, 204, 206, 208 and 210 which are functionally connected to one another over a network such as a Local Area Network (LAN) or possibly a Wide Area Network (WAN). As discussed above, a trigger event causes information associated with the event to be sent to one or more ancillary systems. Many types of HL7 messages are generated in response to a trigger event. As such, the transaction is termed an “unsolicited update”. Ancillary applications that need event information from a trigger event must listen for a message containing the unsolicited update information values.

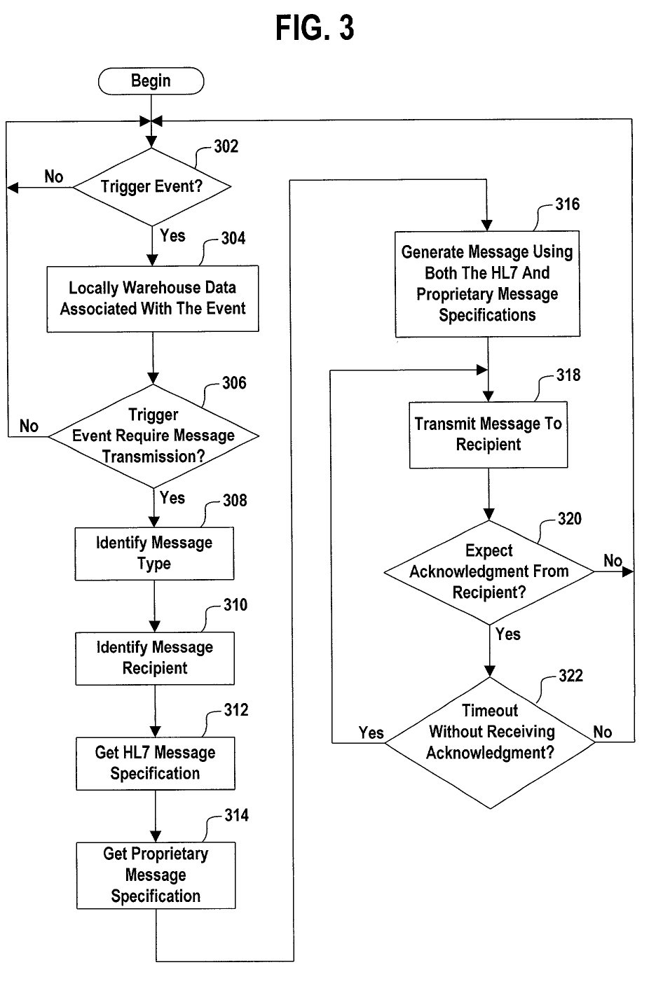

The process by which a disparate, ancillary system handles message generation using a standardizing messaging protocol in response to a trigger event is depicted in FIG. 3. Initially, each of disparate, ancillary systems 202, 204, 206, 208 and 210 are in a ready state waiting for the occurrence of a trigger event (step 302). Once a trigger event is detected, the event is immediately identified and the event information is processed and stored locally in accordance with vendor-specific rules (step 304). Next, the disparate, ancillary system processing the event determines whether to generate a HL7 compliant message with the event information (step 306). If a message is not to be generated, the system returns to the ready state and the process returns to step 302. If a compliant message is to be sent to another ancillary system, then the application processing the event information must first identify the appropriate HL7 message type by the event type (step 308). Once the message type has been identified, the event processing application identifies all disparate, ancillary systems that are to be sent the message. The systems are identified by their applications' socket addresses (step 310). Here, the event processing application usually looks up the recipient socket numbers associated with an event type. Of course, it is the responsibility of ancillary systems that need event information to provide the ancillary application that processes that event information with their socket address. Next, the message must be formatted in accordance with the HL7 messaging specification (of course, any messaging protocol might be equally applicable) thus, the messaging specification must be accessed (step 312).

It should now be understood that even though a standardized messaging specification has been implemented across disparate, ancillary systems in an enterprise, an auxiliary specification is often necessary to handle ambiguities, harmonize definitions and specify options, usually between at least two disparate vendor applications. Therefore, after the messaging specification has been accessed, the event processing application then accesses an auxiliary (or its proprietary) messaging specification (step 314). While the auxiliary messaging specification may be a vendor-specific specification intended for use only with vendor supplied systems, it is more likely that the proprietary messaging specification is an auxiliary specification compiled by vendors whose applications support an enterprise. Although rare, it is possible that a particular trigger event might mandate the generation of multiple messages, each message being generated in accordance with a recipient-specific specification. However, it is more likely the processing application would use a single auxiliary specification for message generation. A recipient application would then be responsible for accessing the correct proprietary specification for sending and deciphering incoming messages from the sender using the sender's specification.

One or more messages are then generated using both the standard messaging specification and the propriety specification (step 316). The messages are transmitted to the recipient applications' socket addresses (step 318). The processing application may or may not receive an ACK (acknowledgment) message from the recipients. If a recipient application is so configured, it may acknowledge the message by sending an ACK message to the processing application and even provide an error log in a message error segment. Therefore, a processing application may retain instances of transmitted messages in case one or more of the messages must be retransmitted. Therefore, the processing application determines whether or not to expect an ACK message from a recipient (step 320). If an ACK message is not expected, the ancillary system concludes processing of the current trigger event and the process returns to step 302 where the event processing system returns to the ready state. However, if the processing application identifies a recipient application that is configured to acknowledge the event message, the process monitors the time since transmission of the event message (step 322). If the processing application receives an ACK message within a preset time period, the process ends. If not, the process reverts to step 318 where another instance of the message is retransmitted to the recipient application and the time period restarts. The event processing application cannot end the current messaging process until the acknowledgement has been received from the recipient system (at least not without several attempts to communicate with the recipient). If a predetermined number of messages have been sent to the recipient without an acknowledgement, it must be assumed that the recipient system is not listening or cannot respond. In that case, the process ends without an acknowledgment and the process returns to step 302 with the processing system returning to the ready state.

With respect to the description above, as an ancillary application receives a triggering event, that application sends an unsolicited message to one or more system based socket numbers associated with the event type. If an ancillary system is listening at that socket, it will pick up the message and attempt to process it. However, a considerable number of problems may occur between ancillary systems that are attempting to communicate event information. For example, a recipient application might not be listening or may fail to understand the data in the message. Alternatively, the socket number used by the event processing application may not define a valid destination application. Because the event processing application may know the recipient application by a socket number only, the event processing application assumes that the recipient receives every event message. Still, other problems occur when the recipient application attempts to process the message in a manner that is inconsistent with the processing application's messaging specification.

The prior art has attempted to solve many of these problems by employing a myriad of intrusive solutions. Most solutions were based on the premise that no assumption could be made about the design or architecture of either the sending or receiving application. Thus, the easiest solution required that vendors communicate with each other and define rules for handling ambiguities, harmonizing definitions, specifying options and reassigning conflicting port numbers used to link incoming data to the correct applications. These solutions required each vendor to keep abreast of its competitor's technology by relying on disclosures from the competition.

A second tact was to strengthen the standards. To that end, messaging standards were introduced which required that an original mode acknowledgment be returned whenever an unsolicited update was received. By requiring each ancillary application to respond to an event message with an acknowledgment message, the burden of “listening” was more evenly divided between sending applications and receiving applications. A sending application could no longer “send and forget” an event message but instead, was required to retransmit the event message if an acknowledgment was not forthcoming from the recipient system. On the other hand, recipient systems were relieved of the consequences of the network faults occurring between their socket and the sender system. Utilization of the acknowledgment message also relieved a recipient of the responsibility of listening. Transitory lapses in listening were tolerated because the sending system was required to retransmit event messages that were not acknowledged by a recipient system. Other improvements were also employed to ensure that the recipient understood the information contained in an event message. Standards bodies attempted to harmonize definitions and remove ambiguities wherever a consensus of members agreed. Rules that were previously optional were made mandatory. New, more generic open standard text languages were implemented including XML (extensible Markup Language). Often, however, the standard's strengthening and harmonization efforts were no more successful than previous efforts that produced weak, guideline-like standards rules.

A third effort came by way of relieving individual vendors of the responsibility for the monitoring of each other's application system changes. The introduction of the Automated Interface Gateway (AIG pronounced “egg”) to intercept and reroute messages between ancillary system applications was directed to that end. AIGs, or interface engines, are generally data integration tools that allow information in the form of messages, records, or transactions to be exchanged, routed, and translated between dissimilar systems and applications. The Integrator and Cloverleaf are examples of interface engines and available from Healthcare.com, Inc., 15301 Dallas Parkway, Dallas, Tex. 75248-4605.

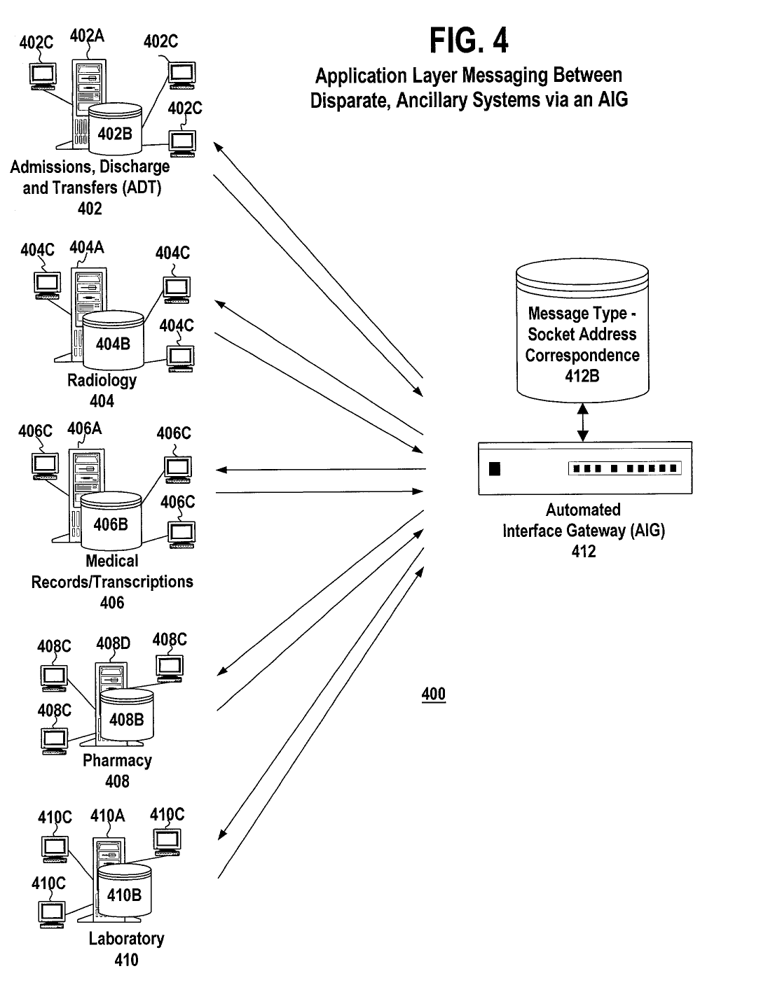

FIG. 4 is a functional diagram of an enterprise network which utilizes an automated interface gateway for routing level seven event triggered messages. FIG. 4 depicts enterprise network 400 that comprises several disparate, ancillary systems each functionally connected to an Automated Interface Gateway (AIG). Admissions, Discharge and Transfers (ADT) 402, Radiology 404, Medical records/transcriptions 406, Pharmacy 408 and Laboratory 410 are identical to disparate, ancillary systems depicted above with respect to FIG. 2. Again, the depicted systems are merely illustrative of disparate, ancillary systems which may be present within a health care enterprise and one of ordinary skill in the art would readily realize that other systems may be present in combination or in place of the exemplary systems. As discussed with respect to FIG. 2 above, each of the respective disparate, ancillary systems utilize servers 402A, 404A, 406A, 408A and 410A for processing information to and from their respective terminals 402C, 404C, 406C, 408C and 410C and storage units 402B, 404B, 406B, 408B and 410B. However, unlike the disparate, ancillary systems depicted in FIG. 2, whenever any one of servers 402A, 404A, 406A, 408A and 410A generate a HL7 compliant message, the message is directed AIG 412 rather than sending the message to a recipient system based on the event type. Message transactions are represented by arrows to and from each of the disparate, ancillary systems 402, 404, 406, 408, 410 and AIG 412.

Including addressability, utilizing an AIG for routing messages between systems has several immediate benefits over system-to-system messaging. When an enterprise configures an AIG in its network, all event messages are initially addressed to the AIG socket rather than to the individual ancillary applications. Thus, an event processing application is freed from maintaining a correspondence table of application socket addresses and event types. Any message generated as result of an event is transmitted to the AIG. The AIG also handles responses, such as ACK messages, thereby freeing resources in the event processing application for other tasks immediately after the AIG receives the event message. Also, with an AIG in place, the event processing application need only send a single event message in response to any trigger event, thereby freeing even more system resources.

By maintaining a comprehensive list of message/event type correspondence tables for all application sockets registered in the enterprise, AIG 412 relives individual vendor applications from the burden of maintaining an extensive list of event (message) type socket addresses. Regardless of the event type, the processing application merely routes the event message to the AIG. Upon receipt by AIG 412, the event processing application (sending system) is identified and the message address layer (TCP/IP layer) is stripped away. AIG 412 then identifies the message and event types from the message header segment (MSH) and the event type segment (EVN), respectively. Using the message/event type information, AIG 412 looks up corresponding recipient application socket addresses using a message/event type socket address correspondence table stored in AIG database 412B. The original HL7 event message body is then repackaged in event messages with the respective recipient application socket addresses. The repackaged event messages are then sent to the respective recipient applications over enterprise network 400. After the event messages are sent, AIG 412 assumes the responsibility for retransmitting any undelivered HL7 event messages to any recipient applications not responding with an ACK message within a preset time period.

The description above provides a greatly simplified view of the workings of a messaging interface engine. It is understood, however, that every vendor relies on the AIG for routing event messages to and from its ancillary applications in an enterprise. In order to assure receiving critical event messages, each vendor is therefore behooved to expeditiously update the AIG database with internal vendor specification changes, updated socket addresses, etc. However, even though the AIG greatly increases messaging reliability between disparate, ancillary systems in an enterprise, many of the shortcomings inherent in the prior art still exist. For instance, ambiguities, optional parameters and outright contradictions in the HL7 specification still necessitate each vendor maintaining auxiliary specifications for all other vendor applications in the enterprise. Even in enterprises where event data is freely and accurately transmitted between ancillary applications, the event data is still stored and maintained at a system level. An enterprise level view of data stored in the respective ancillary databases is impossible because each database maintains only a system level image of its data. Attempts to piece together an enterprise level answer from the ancillary system's present enterprise network 400 is extremely difficult because each ancillary system maintains separate database rules for structuring, storing and interfacing its respective data. Enterprise users not only have to be familiar with the specific data elements stored in disparate system's database, but the user also must maintain the proficiency necessary on that system's interface to drill down into a particular database and acquire the data.

In response to many of the additional shortcomings of the prior art, the enterprise network was further modified to restructure system level HL7 message data to an enterprise standard. Event data processed at a system level can, therefore, be stored and retrieved in an enterprise database. While the prior art teaches storing and retrieving event data to and from a master enterprise database heretofore, the preferred method was to migrate each of the disparate, ancillary applications to an enterprise application and disband the ancillary systems altogether. Individual enterprise departments gave up their ancillary systems for an enterprise system. Department ISS personnel, who once specialized on the ancillary system applications and databases, are absorbed, as needed, into an enterprise ISS. While the wholesale migration of system level applications and databases to an enterprise solution may provide the most expedient path to enterprise level IS answers, the path is fraught with expense and disruption for the enterprise.

An alternative to migrating to a system wide enterprise solution is to layer an enterprise level solution over the existing system level application structure. The AIG interface provides a ready port for connecting to an enterprise level database for storing event data that is organized based on enterprise level information priori rather than the individual system level information structures. Event messages broadcast from the AIG may be transmitted, simultaneously, to a system/enterprise interface engine. This interface engine converts HL7 compliant messages to an enterprise message capable of being processed by an enterprise server. The enterprise server then, among other functions, warehouses the event data, that was converted from HL7 messages, in an enterprise database. The functionality of the individual ancillary system applications remains unmodified and each ancillary system continues to process event information and stores the information locally as described above. With this improvement, the enterprise server processes transactions directly from the enterprise user. Additionally, event information is available to the enterprise server from an enterprise level data stored in the enterprise database. Thus, it is no longer necessary for the enterprise user to drill down into ancillary databases using ancillary system tools.

Briefly, the message/event type socket address correspondence table stored in AIG database is updated with an additional socket address for the system/enterprise interface engine, known as the AIG catcher. The AIG catcher receives and opens HL7 event messages from the AIG and accesses the message body. Each data value in the message body is then mapped to a corresponding enterprise value in an enterprise message body. Once an HL7 message's event data is converted from its original, vendor-specific variant of the HL7 protocol into enterprise structured data, the enterprise message is passed to an enterprise server, where it is processed and written into an enterprise database. Rather than being system specific, as are the ancillary system databases, the enterprise database is enterprise specific. Therefore, in addition to processing any requested transactions, whenever an enterprise message arrives at the enterprise server, the server can autonomously process a variety of additional enterprise transactions related to either the message data or the requested transaction. Processing these related transactions might require that the enterprise server retrieve additional enterprise data from the enterprise database. Access to enterprise level data stored in the enterprise database is further provided to authorized web appliances connected to a web server that is also connected to the enterprise server.

Heretofore, the prior art disparate, ancillary systems were fashioned such that each system's applications relied only on its own internal data. Other than event data received in an HL7 message from another system, applications could not establish functional relationships with data in another application's database. In accordance with an exemplary embodiment of the present invention, the enterprise server establishes functional relationships between seemly disparate event elements. These functional relationships could not be recognized by prior art systems as they processed event data at a system level.

An example of a functional relationship heretofore unrecognized by the prior art involves the occurrence of a trigger event, such as a medical practitioner prescribing a course of respiratory therapy for the patient on an ancillary system, the Medical Records system. Normally, in a prior art enterprise, the physician's order is transcribed by Medical Records' personnel and then the patient's whereabouts are determined by accessing the ADT database. A hard copy of the physician's order is then routed to the nurses' station responsible for monitoring the patient's hospital room. Once the hard copy is received at the nurses' station, a nurse looks up the name and notification information for the respiratory care therapist responsible for the patient's room. The nurse attempts to contact the therapist, usually by telephonic paging. Eventually, the therapist gets the message and attempts to confirm with the nurse by telephone. Scheduling a therapist may take several iterations of paging attempts and return telephone calls. The physician's order also triggers an HL7 message for Patient Billing, ADT, etc. In contrast to the prior art and in accordance with the present invention, a physician's scheduling order for a course of respiratory therapy is received by the enterprise server as an enterprise message, e.g. a request for service. The enterprise application accesses patient information, respiratory therapy duty roster and therapist notification information from the enterprise database. Next, prior to actually processing the physician's service order transaction, the server application locates the patient's assigned floor, room and bed and identifies the therapist and nurses' station assigned to cover the patient's room and bed. The enterprise application notifies both the appropriate therapist and nurses' station of the pending order and only then does the enterprise application process the physician's service order transaction. The physician's service order transaction is supplemented with information acquired by processing the related transactions, such as the patient's location, therapist identity and nurses' station.

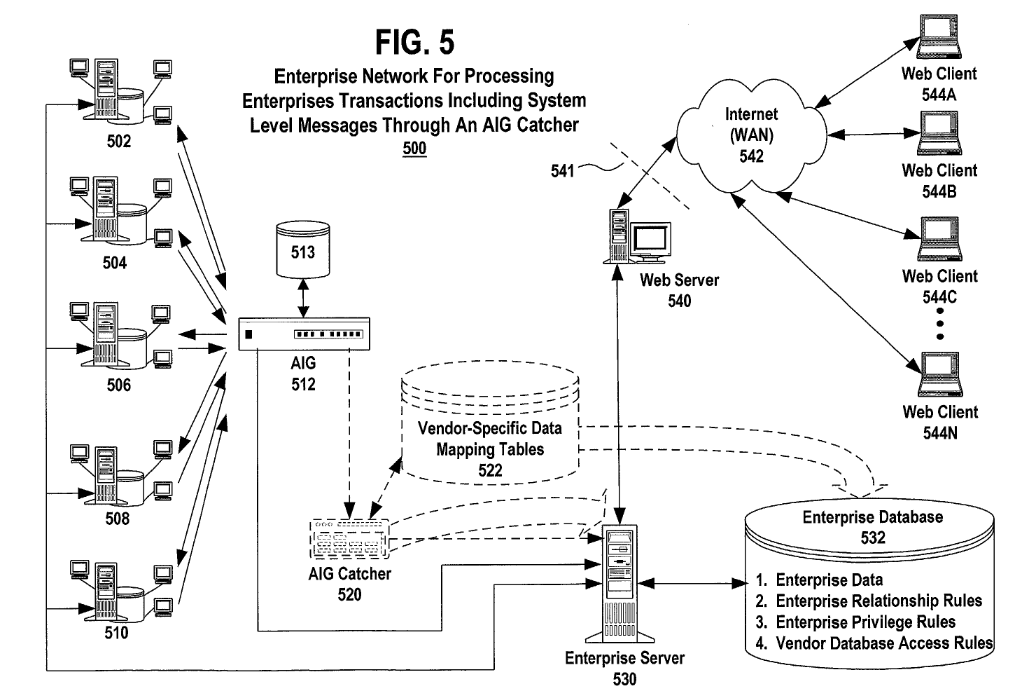

With respect to FIG. 5, a diagram of an enterprise system, including a plurality of disparate, ancillary systems, is depicted for processing enterprise message transactions in accordance with an exemplary embodiment of the present invention. An enterprise message, in accordance with an exemplary embodiment of the present invention, is compliant with proprietary enterprise messaging standards with respect to an enterprise messaging standard or specification. These standards are derived by the enterprise in furtherance of a defined enterprise information priori. In one exemplary embodiment, the enterprise messaging specification is similar, and in fact, based on the HL7 framework. In other embodiments, the enterprise messaging specification is based on a vendor's messaging framework of an existing enterprise system. Using this second messaging framework positions the enterprise for deferred, but eventual, migration of each of the disparate, ancillary systems to an enterprise system.

Although and in accordance with the depiction shown in FIG. 5, the network elements are shown as physical network elements. In practice, certain network elements are actually logical sub-components of other physical network elements. For example, AIG catcher 520 is depicted as a unique physical structure with its own storage, vendor specific mapping tables 522, that is separate and apart from enterprise server 530. However, in practice, the functionality of AIG catcher 520 is contained within enterprise server 530 and the information on vendor specific mapping tables 522 is actually stored on enterprise database 532. It is possible to configure enterprise system 500 in accordance with either embodiment however, the present invention will be described as each network element being a separate physical element. Logical network elements that, in practice, are not configured as separate network elements are show in dashed lines while physical elements are shown as solid lines.

At the center of the enterprise system is enterprise server 530 which supports an enterprise application. Enterprise server 530 may be, for example, an IBM RISC/System 6000 system, a product of International Business Machines Corporation in Armonk, N.Y., running the Advanced Interactive Executive (AIX) operating system or alternatively could include an Intel based Symmetric MultiProcessing (SMP) server such as available from Dell Computer Corporation, One Dell Way, Round Rock, Tex. 78682 and Compaq Computer Corp., 20555 SH 249, Houston, Tex. 77070, etc. running Microsoft Windows NT operating system (Windows NT a trademark of and available from Microsoft Corporation, One Microsoft Way, Redmond, Wash. 98052); an Intel based SMP server (any vendor) running LINUX, etc.; or SparkStations, etc. (SparkStations is a trademark of and available from Sun Microsystems, Inc., 901 San Antonio Road, Palo Alto, Calif. 94303). In practice, current code is only supported on Windows NT servers but, the ordinarily skilled artisan could readily duplicate this, write their own code, to be supported and run on any platform for processing data and requests to and from enterprise database 532. Enterprise server 530 receives enterprise messages from any one of a number of sources including web server 540, AIG catcher and under certain circumstances, any one of disparate, ancillary systems 502 to 510. Ancillary systems 502 to 510 correspond to systems 402 to 410 described above with respect to FIG. 4 and may include, for example, ADT, Radiology, Medical Records and Transcriptions, Pharmacy, and Laboratory Systems, etc.

Enterprise server 530 may be a symmetric multiprocessor (SMP) system including a plurality of processors connected to a system bus or alternatively, a single processor system may be employed. Also connected to system bus is local and memory controller/cache, which provides an interface to the local memory. An I/O bus bridge is connected to the system bus and provides an interface to the I/O bus. Peripheral component interconnect (PCI) bus bridge connected to the I/O bus provides an interface to the PCI bus and a number of modems may be connected to the PCI bus. Communications links to network computers, including web server 540 and AIG catcher 520 may be provided through a modem, but more likely, using one of a plurality of network adapters connected to the PCI local bus or the I/O bus. Those of ordinary skill in the art will appreciate that the hardware described above is exemplary and may vary from server to server based, among other factors, on enterprise needs. For example, other peripheral devices, such as optical disk drives and the like, may also be used in addition to or in place of the hardware depicted. The depicted example is not meant to imply architectural limitations with respect to the present invention. Enterprise server 530 may be, for example, an IBM RISC/System 6000 system, a product of International Business Machines Corporation in Armonk, N.Y., running the Advanced Interactive Executive (AIX) operating system.

Enterprise server 530, as depicted in FIG. 5, functions as a database server. Enterprise server 530 processes database storage and retrieval requests from enterprise clients by utilizing an enterprise database management system (DBMS) and for managing information in enterprise database 532. Exemplary DBMSs include Sybase (a trademark of and available from Sybase Inc., 6475 Christie Avenue, Emeryville, Calif. 94608) and Oracle (a trademark of and available from Oracle Corporation, 500 Oracle Parkway, Redwood City, Calif. 94065) for applications on NT/UNIX platforms and also Microsoft SQL Server for NT operating systems (both trademarks and available from Microsoft Corporation). Upon requests from the enterprise clients, such as web clients 544A-544N, Enterprise server 530 searches enterprise database 532 for selected records and passes them back to the requestor over the network. The implementation of enterprise server 530 allows enterprise data to be requested, modified and imaged at an enterprise level rather than at a sub-enterprise or system level as was common in the prior art. Therefore, rather than the user being forced to access system level information at each one of the separate ancillary systems 502 to 510, an enterprise user may, instead, access enterprise level information contained within enterprise database 532 through enterprise server 530 via, for example, web server 540.

Web server 540 makes world wide web services on the Internet available to enterprise server 530. Web server 530 includes hardware and operating systems similar to that described above with respect to enterprise server 530, but also includes web server software, TCP/IP protocols and the web site content (enterprise web pages). Web server 540 is also configured with a firewall for keeping the enterprise network secure from web born attacks by filtering out unwanted packets. As web server 540 is actually used internally by the enterprise and not by the public, web server 540 is actually an intranet server or application server. A primary function of web server 540 is to manage web page requests from web browsers and delivers HTML (Hyper Text Markup Language) documents (enterprise web pages) in response using the HyperText Transport Protocol (HTTP). Web server 540 also handles all application operations between browser-based computers (any of web clients 544A-544N) and the enterprise's back-end enterprise applications and enterprise database 532. Additionally, web server 540 provides all the Internet services necessary to the enterprise, in addition to a HTTP server, web server 540 functions as a FTP server (file downloads), NNTP server (newsgroups) and SMTP server (mail service). An operating system runs on one or more processors on web server 540 and is used to coordinate and provide control of various components within. The operating system may be a commercially available operating system such as a UNIX based operating system, AIX for instance, which is available from International Business Machines Corporation. “AIX” is a trademark of International Business Machines Corporation. Other operating systems include OS/2 (a trademark of and available from IBM); Windows NT and Linux (available from Red Hat, Inc., 2600 Meridian Parkway, Durham, N.C. 27713). An object-oriented programming system, such as Java, may run in conjunction with the operating system and provide calls to the operating system from Java programs or applications executing on web server 530. “Java” is a trademark of Sun Microsystems, Inc. Instructions for the operating system, the object-oriented operating system, and applications or programs are located on local storage devices and may be loaded into main memory for execution by the one or more processors. FIG. 5 depicts web server 540 and enterprise server 530 as separate enterprise network components however, ordinary artisans will readily understand the one physical server might function as both an application server, database server and a web server. In accordance with one embodiment, an Intel-based multiprocessor server running Microsoft Windows NT operating system and Internet Information Server (IIS) web server. web pages are coded with a mixture of HTML and embedded Microsoft VBScript running as Active Server Pages (ASP available from Microsoft Corporation). web server programs make calls directly to enterprise database 532 via ODBC connection (Open Database Connectivity—this is an industry database connection standard) using the Microsoft ADO (ActiveX Data Objects available from Microsoft Corporation) object model programmatically. The volume of the enterprise requests and/or data growth might dictate that web “farms” of many connected and synchronized web servers, as well as a multitude of database servers, to handle the increased volume and throughput. An alternate embodiment would be HTML and Computer Graphics Interface (CGI) based web site coded in Java, JavaScript (both available from Sun Microsystems Corporation), Practical Extraction Report Language (PERL), etc. with access to the enterprise database via Java Database Connectivity (JDBC available from the Sun Microsystems Corporation), Open Database Connectivity (ODBC available from Microsoft Corporation), connections and related data object models.

In accordance with an exemplary embodiment of the present invention, the enterprise application enables physicians, clinicians and other care providers the means for web-based access to enterprise level functionality and enterprise data at every workstation connected to the enterprise network within a physical enterprise department. A convention web browser is used for this purpose. By using a web browser over standard Internet connections, authorized users may also securely access the enterprise system from remote locations such as home or office. Every enterprise user is given an enterprise web page that maintains current enterprise content related to the user. The user merely logs onto the enterprise network and views the personnel enterprise web page. At that point, the user can navigate to other enterprise data and functionality which is displayed in a like manner over the user's browser. A brief overview of exemplary enterprise supported applications includes individualized enterprise screens for general enterprise user sign-on, patient census, clinical results, cumulative laboratory reports, physician credentials, detailed laboratory reports, consent forms, medical histories, patient demographics and medical references.

However, prior to accessing any enterprise service, a user must be authorized by the enterprise system, a generic enterprise sign-on screen is used for that purpose. The generic enterprise user sign-on is a screen used to sign on to the enterprise system and typically queries a user for a unique user identification (ID) and password. Once signed on, care providers are allowed to view clinical information about patients across the continuum of care.

A patient census is crucial clinical information that provides care providers with a list of patients by name, patient number, nursing unit, room number, admit date and admitting diagnosis. Because the patient census information, as is all other information, is maintained as enterprise level data, the care provider has to access other enterprise data as it relates to particular patient information. Likewise, a user may customize the census view to satisfy their specific needs. One type of enterprise data that is related to the patient, or at least to some type of patient data (patient ID for instance), is clinical results. The clinical results section on a user web page notifies the user that patient test results are available for a particular patient. The clinical results section functions as an electronic in-basket for all test results under the control of the user. From the clinical results section, a care provider can bring up views transcribed radiology reports, laboratory results and medical records transcriptions such as History and Physicals. Both interim and final results notifications are posted and these results are easily identifiable as normal or abnormal as will be described in greater detail below. Cumulative laboratory report notifications are also posted clinical results section of the users web page. The cumulative laboratory report identifies laboratory tests across results and displays them in a format used for comparisons. Unlike hard copy laboratory results or utilizing the ancillary laboratory system for a display, the enterprise network notifies a user that unviewed test results are available to the user and the cumulative laboratory report is designed to give care providers views of recent laboratory results proximately displayed with previous results. Again, because the enterprise laboratory data is related to a particular patient ID, for instance, the care provide has the additionally ability to “drill down” on individual results for more specific detail or additional historic laboratory data for the patient with one click of a button. Alternatively, or in addition, a care provider may view an enterprise detailed laboratory report for a patient after notification on the user's clinical results section that the report has been compiled.

In addition to more care provider-specific support, such as clinical results and for expediting authorizations to enterprise services and information, the enterprise system also allows enterprise employees ready access to up-to-date care provider credentials, including recent images of a care providers. The care provider's credentials feature allows key enterprise personnel to view credentialing and privileging information for all of credentialed care providers, such as physicians. Enterprise personnel assigned to individual departments have access to a care provider's picture, demographic information (office address, phone numbers, provider numbers, etc.) and if authorized, department employees may also view care provider privileges and specialties.

Recently, the proliferation of enterprise paperwork and documentation required by state and federal jurisdictions has overwhelmed enterprise employees and care providers alike. Merely managing consent forms has become a cottage industry within healthcare because of their complexity and uniqueness to a specific procedure. Most informed consent laws require that specific information related to a procedure be disclosed to the patient prior to that procedure being preformed. From time to time regulatory panels recognize that the disclosure information should be updated, making older versions of the consent form inaccurate. Health care enterprises that do not use the most up to date consent form versions may not enjoy the benefits of that which informed consent laws provide to the enterprise. In accordance with an exemplary embodiment of the present invention, consent forms are managed by the enterprise application and the most up to date releases are available on the enterprise database. More specifically, the latest release of a consent form for a procedure is linked to that procedure and viewable on a web page and printable for the patient's signature. Multiple consent forms are similarly available for patients scheduled for multiple, simultaneous procedures. A care provider can even review medical records for a patient to view copies of previously signed consent forms. For procedures in which the content of the consent form has not yet been covered by a regulatory panel, they are then linked to a blank consent form.

One shortcoming of most systems that rely on paper records is the immediate availability of medical history data for a patient. Given time, all patient medical history data can be routed to the care provider, often, however, there is simply no time to assemble the paper copies prior to a procedure or admission. Therefore, in accordance with another exemplary embodiment of the present invention, prior admission data for a patient into a health care facility can be accessed from the patient census data. Again, because all admission data is relationally linked to the patient ID as enterprise data, access to prior admission information is displayed by navigating through the desired patient name and then across a screen listing previous encounters. A particular encounter may be selected by a point and click on the displayed encounter information to get details. In addition, demographic information for the patient may be displayed in a similar manner to view on-line. Patient demographics provide basic information such as name, address, phone number, as well as information on insurance, guarantor, employment and emergency contacts. Finally, the enterprise system provides a convenient tool for assimilating health care reference information and sources. Internet sites, which should be of interest to care providers, are easily communicated to individual health care providers through their individual web pages. From there, a provider can merely navigate to the site. Additionally, enterprise subscriptions to journals and pay-per-view articles can be managed through the care provider's log in ID and web page and, similar to other enterprise services, is readily available from any network-attached workstation and may be securely viewed from their home or office, any web client or appliance connected to the Internet.

Returning to the description of web server 540, as understood by ordinary artisans in the art, is connected through WAN 542 to any of a plurality of web clients 544A to 544N. web server 540 is located behind firewall 541 and therefore is actually used internally by the enterprise and not by the public, web server 540 is actually an intranet server or application server. All applications are available from the “Internet” via Secure Socket Layer (SSL) connection to the enterprise web server behind firewall 541 (in practice, often a web server is logically positioned between two firewalls, an internal fire wall separating the web server from the intranet and an external fire wall separating the web server from the WAN or Internet). Enterprise users do, in fact, have access to the enterprise server and enterprise data via the Internet. Privacy and/or security is ensured via standard SSL website certificate encryption and programmatic authentication. A “trusted” hole is punched through firewall 541 so that web clients 544A-544N can talk to enterprise database server 530. Here, “hole” is defined as a unique internal enterprise TCP/IP address and dedicated PORT/socket number on that IP. Programmatic authentication consists of checking a supplied user ID and password against the known users in the enterprise database at sign-on. This is common practice in the industry such that ordinary artisans will understand.

Web clients 544A to 544N may be any one of a variety of browser-based data processing systems including PCs, Net Computers (NCs), network computers or any web enabled appliance, for instance a Personal Digital Assistant (PDA). A WAN, such as the Internet, allows enterprise users to access enterprise data and execute enterprise applications from many TCP/IP enabled ports. Thus, a user, such as a physician, could access patient information and/or place orders from any PC or net appliance connected to the Internet.

Requesting certain enterprise services, such as those supported by one of ancillary systems 502-510, requires that the particular enterprise department providing the service be connected to one of web clients 544A-544N. Although enterprise server 530 is functionally linked to each of ancillary systems 502 to 510, in general, it is expected that a communication link between ancillary systems 502 to 510 and enterprise server 530 is one way and not by directional communication via AIG catcher 520. Thus, an enterprise user must convey a request for an enterprise service through an existing media, such as telephonically, orally, via support technicians or hard copy request forms and documents and that request must be placed with the specific disparate ancillary system that controls the requested system level information. However, rather than the user being forced to access system level information at each one of the separate ancillary systems 502 to 510, an enterprise user may, instead, access enterprise level information contained within enterprise database 532 through enterprise server 530 via, for example, web server 540.

AIG catcher 520 is functionally connected to AIG 512, which was described above with respect to AIG 412 in FIG. 4. Remembering that AIG 512 could be simplistically analogized as a router because its primary function is for redirecting messages from one disparate, ancillary system to another by re-addressing messages using socket addresses from a message type/socket address correspondence tables stored in database 513. Each time a message is received at AIG 512 from one of the ancillary systems, the message type/socket address correspondence table in database 513 is accessed for a destination socket address for the particular type of message. The only departure from the functionality described above is that the message type/socket address correspondence table contains the socket address of AIG catcher 520 corresponding with each possible message type. Therefore, for each message received by AIG 512 from any one of ancillary system 502 to 510, an instance of that message is sent to each ancillary system, which might be listening for the message and also to AIG catcher 520. Hence, AIG catcher 520 receives a copy of every message received by AIG 512.

In accordance with an exemplary embodiment of the present invention, the AIG catcher functionality is a program written as an NT service to run on an application server. In this case, one running the Microsoft Windows NT operating system. The service is written as a TCP/IP sockets program such that it constantly listens on a predefined (HL7) port waiting to receive a standard HL7 message. Once received, it will process the HL7 message as described in the HL7 processing section and send an ACK acknowledgement back to the sending application, AIG 512.

As discussed above, the HL7 messaging specification includes message structure definitions and data element and attribute definitions. However, as discussed in several passages above, some definitions specified in the standard are ambiguous, while others are merely optional. Therefore, vendors, whose applications communicate with one another, normally agree on an auxiliary messaging specifications to remedy ambiguous definitions and specify optional definitions. Often, the combination of the HL7 and auxiliary specifications is sufficient for deciphering each other's messages. Nevertheless, the HL7 messaging framework sanctions the use of proprietary data elements, attribute definitions and proprietary messaging structures. Some vendor's, especially those supporting applications that message one another, develop proprietary messaging specifications for messaging between their own applications in accordance with the HL7 messaging specification. Consequently, in order to completely decipher a vendor's message, information from the vendor's proprietary messaging specification must be used as well as the HL7 and auxiliary specifications.

AIG catcher 520 does not merely decipher each message, but it also converts HL7 compliant data element values to enterprise-specific data element values and then generates an enterprise message with those enterprise values. The process of converting messages from the HL7 standard to an enterprise standard message can be described as essentially a three-step process: 1) identify each data element value occurring in each segment field in the HL7 message, 2) convert the identified data elements from vendor-specific, HL7 messaging values to enterprise-specific values, and 3) generate an enterprise message using the enterprise-specific values. A data element value associated with any HL7 compliant segment field may be defined by either the HL7 messaging specification, an auxiliary and a vendor's proprietary messaging specification. Therefore, in order to accurately identify every value in each message, the AIG catcher must utilize information from the HL7 messaging specification as well as each vendor's auxiliary and proprietary messaging specifications. Additionally, by using enterprise messaging specifications, vendor-specific conversion rules must be formulated for converting vendor-specific, HL7 data element values to enterprise-specific data element values. Once a vendor-specific, HL7 compliant data element value is identified, the vendor-specific conversion rules can be used by AIG catcher 520 to convert the data element value to an enterprise-specific data element value. An enterprise message is then generated from all enterprise data element values converted from the HL7 message using the enterprise specification. The information needed by AIG catcher 520 for identifying, converting and message formatting HL7 data is stored in AIG catcher database 522.

Alternatively, HL7-to-enterprise data-mapping tables can be used for mapping vendor-specific data element values from a particular type HL7 message directly to a corresponding enterprise-specific data element in a corresponding type of enterprise message. A series of HL7-to-enterprise data mappings are constructed based on the correspondences between definitions in the HL7, auxiliary and proprietary messaging specifications and a set of enterprise messaging definitions. A separate HL7-to-enterprise data-mapping table is formulated for each message/event type. These HL7-to-enterprise data-mapping tables are held in AIG catcher database 522. Generally, its expected that AIG catcher 520 will receive a particular HL7 message type, that is triggered by a specific event, from only a single ancillary system. The correct HL7-to-enterprise data-mapping table can be surmised from the message/event type information alone, therefore, identifying the vendor is not important. Using the HL7-to-enterprise data-mapping table, each HL7 defined data element value retrieved by AIG catcher 520 from an HL7 message can be mapped to a corresponding enterprise data value and then that enterprise data value is entered into its proper position in an enterprise message. However, in the unusual situation where identical HL7 message/event types received by AIG catcher 520 are generated by more than one vendor's application, the HL7-to-enterprise data-mapping tables stored in AIG catcher database 520 would be vendor-specific. Prior to accessing a table, the vendor's identity must be determined (usually from the transport and/or message header), along with the message and event type information.

Once the enterprise message has been generated from an HL7 message, AIG catcher 520 transmits the enterprise message to enterprise server 530. The function of the enterprise server is to execute the message transaction, but before performing the message transaction, the enterprise application may perform related enterprise transactions. Therefore, whenever enterprise server 530 receives an enterprise message, the enterprise application retrieves enterprise relationship rules from enterprise database 532. Rule retrieval is based on message type information and data content. Using the appropriate enterprise relationship rules, the enterprise application processes the enterprise message by executing all enterprise transactions for the message and then warehouses the results in enterprise database 532. Generally, the results include at least a portion of the enterprise data received from AIG catcher 520. In addition to containing relationship rules for processing enterprise messages from AIG catcher 520, Enterprise database 532 also contains relationship rules for processing any enterprise messages, from one of web clients 544A-544N, or in certain circumstances, even response messages received directly from one of ancillary systems 502-510.

Processing an enterprise message transaction normally involves invoking enterprise relationship rules that define relationships between data element types and transaction types. These relationship rules, or more correctly rule-base executable scripts, may trigger the enterprise application to autonomously perform supplemental enterprise transactions in addition to the message transaction. The enterprise application might also retrieve additional enterprise data from enterprise database 532 necessary for processing either the message transaction or a related enterprise transaction defined by a relationship rule. The particular supplemental enterprise transactions performed by the enterprise application are based on message enterprise data and/or message type information. For example, upon receiving an enterprise message containing laboratory result values for a patient, the enterprise application accesses enterprise relationship rules that specify tolerances for each of the specific laboratory data types. Alternatively, laboratory test tolerances are received embedded in the laboratory test result. When an abnormal or panic test result is received from the inbound lab interface, the enterprise application accesses related physician contact information (physician name, telephonic pager number, email, primary nurse, etc.) and preferred contact method and then contact is made as described below. Additionally, the enterprise application accesses contact information for the patient's attending physician. In the event that any of the laboratory data values exceed a corresponding preset tolerance defined in the enterprise rules for that test, the enterprise application immediately contacts the patient's physician with a warning about the test results. In another instance, immediately after receiving an enterprise message request from a physician for the service, an enterprise application automatically contacts all of the technical personnel necessary for performing a requested service. Here again, the enterprise application looks up enterprise rules (scheduling and notifying technicians to perform the service) based on the message type (a service requested) and enterprise data (service type, patient name etc), prior to executing the message itself. Based on the relationship rules and enterprise data, additional information, such as technician rosters, notification information and patient location, might also be accessed from enterprise database 532.

Also contained in enterprise database 532, and in addition to the enterprise relationship rules, are enterprise privilege rules that specify user privileges to enterprise data within enterprise database 532. Enterprise privilege is based on the identity of the requester and the type of transaction being requested. Below are some exemplary enterprise privilege rules that maybe employed by a health care enterprise:

A) A Physician can only view enterprise patient data for patients that he/she has a direct relationship with (the attending for instance). The enterprise database maintains data fields that identify a patient's admitting, attending, referring and consulting physicians. Also, the enterprise database maintains physician “group” and/or practice relationships among physician users. If a signed in physician is either admitting, attending, referring, consulting, or a member of a group that one of these belongs to, then the physician can see the patient record;

B) Nurse working on a given unit can only see enterprise patient data for patients that are currently in a room/bed on that unit. If nurse physically moves to a different unit and signs on to the workstation at that unit, then they, again, see only patient data for patients in beds on that unit;

C) Nurse manager has supervisory responsibility to one or more nurse units in a hospital. The enterprise database contains database fields that identify the nurse manager's assigned coverage areas. This nurse manager can view enterprise patient data for any patient in a bed on any one of the units that they have supervisory responsibility for;

D) Respiratory Therapist can see patient data for all patients that are in a bed on a nurse unit that they are currently assigned to;

E) Clergical pastor working (volunteering) in a hospital can see demographic information only for patients in the hospital (including religious affiliation) and any clergical notes that were added during the patient's stay. Clergy cannot see any clinical information whatsoever;

F) Volunteer service employees working the “Information Desk” within a hospital lobby can get a list of patient names, age, and current room/bed assignments. This is to tell visitors where an admitted patient can be found; and

G) Volunteers cannot see any clinical data whatsoever. Also, if the patient's admission to the hospital cannot be compromised legally as in the case Behavioral Health, Chemical Dependency, VIP (Governor, President, etc.), etc. then the all data is kept secret.

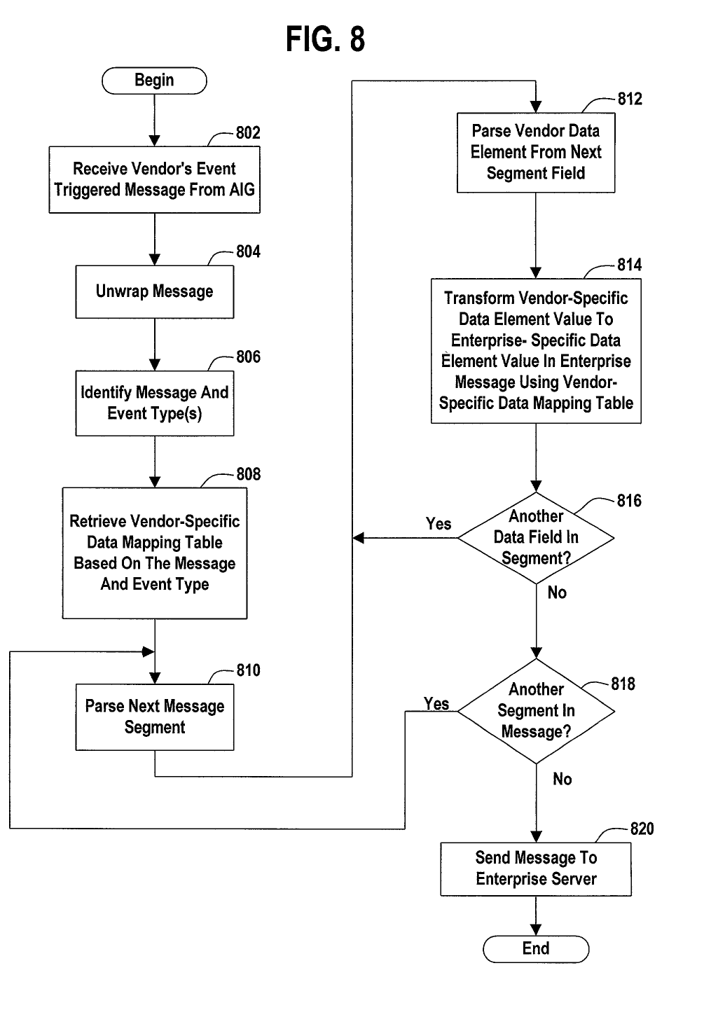

Enterprise privilege rules may also relate to enterprise functionality being requested by a user. Enterprise privilege rules are analogous to system authorization rules common to most network systems, but rather than being based on network system security, these rules are based on enterprise privileges acquired by a user. Of course, in addition to privilege rules, enterprise 500 utilizes system and network security rules. At times, it might appear that the different rules conflict with one another. For example, a user might be authorized by the enterprise security system to particular enterprise data and/or functionality, but may not have the enterprise-bestowed privilege to the particular enterprise data. These pseudo-conflicts may exist because the underlying enterprise privilege policies may differ radically from the enterprise's system or network policies. Enterprise privileges and their function within enterprise network 500 will be described in greater detail with respect to FIG. 8 below.

Finally, enterprise server 530 is functionally connected to each of disparate, ancillary systems 502 to 510 and may, under certain circumstances, communicate directly with those systems. As discussed above, data held in the system databases associated with ancillary systems 502 to 510 are held at a system level rather than at an enterprise level. Similarly, the information stored within each of the disparate system databases is structured based on vendor-defined database rules rather than enterprise rules. Therefore, in order for enterprise server 530 to communicate with and request data from any of the ancillary systems, a group of vendor database access rules must be followed. These rules are also stored in enterprise database 532. Ancillary systems 502 to 510 will only respond to vendor-specific requests from enterprise server 530, whereas messages received from AIG catcher 520 are event triggered. As a result, the enterprise application must send a vendor-specific request to an ancillary system prior to the system's application returning a response message. Vendor data access rules contain vendor-specific messaging specifications for communicating with each ancillary system, as well as vender-specific interfacing rules for drilling down into each ancillary system's database for data retrieval.

One reason for using the enterprise data warehouse concept enterprise database 532 instead of going after the data where it lives in one ancillary system 502-510 is due to the vendor specific rules and/or implementation strategies chosen by the vendor. For example, the life cycle of the clinical information in the hospital information system is such that it may change as the patient moves from admit, to discharge, then to accounts receivable. If it is necessary for the enterprise application system to know the state of the data at admit, then some process must retain that state. Another example would be where the vendor chooses a proprietary or secret data storage technique instead of an industry standard method. Here, the data would be inaccessible without knowledge of the secret routines or vendor-specific decryption keys. Yet another example would be that the ancillary system (for example, a laboratory system) would simply not have the disk capacity to retain data permanently and therefore purge data after the patient were discharged from the hospital. Each of these cases demonstrates a need to warehouse the clinical data for later reference. Our exemplary embodiment thus utilizes the data warehouse concept.

Another function of enterprise server 530 is that it can go directly after data in an ancillary system database associated with one of ancillary systems 502-510 if the vendor's chosen implementation is conducive and/or complimentary to the enterprise application system. For example, a nurse needs access to physician credentialing information to ensure that a particular physician has the required credentials and hospital privileges to perform a given procedure in the hospital. Also assume that the ancillary hospital department responsible for the privileging and credentialing of physicians uses an ancillary computer system with an open architected database backend. Here, the enterprise application can refer to the vendor specific data access and relationship rules. The enterprise application can then use this information to programmatically access the data in the ancillary system directly. The data is then merged with related enterprise data from enterprise database 532 for display and consumption by the enterprise user.

In accordance with an exemplary embodiment of the present invention, the programs (HTML with embedded VBScript in an ASP web page running on an Intel based IIS web server with NT O/S) are written to simultaneously access data from the enterprise databases (ODBC connection) and data from one of the disparate ancillary system database (ODBC connection). The program then logically combines the data for display to the enterprise (end) user.

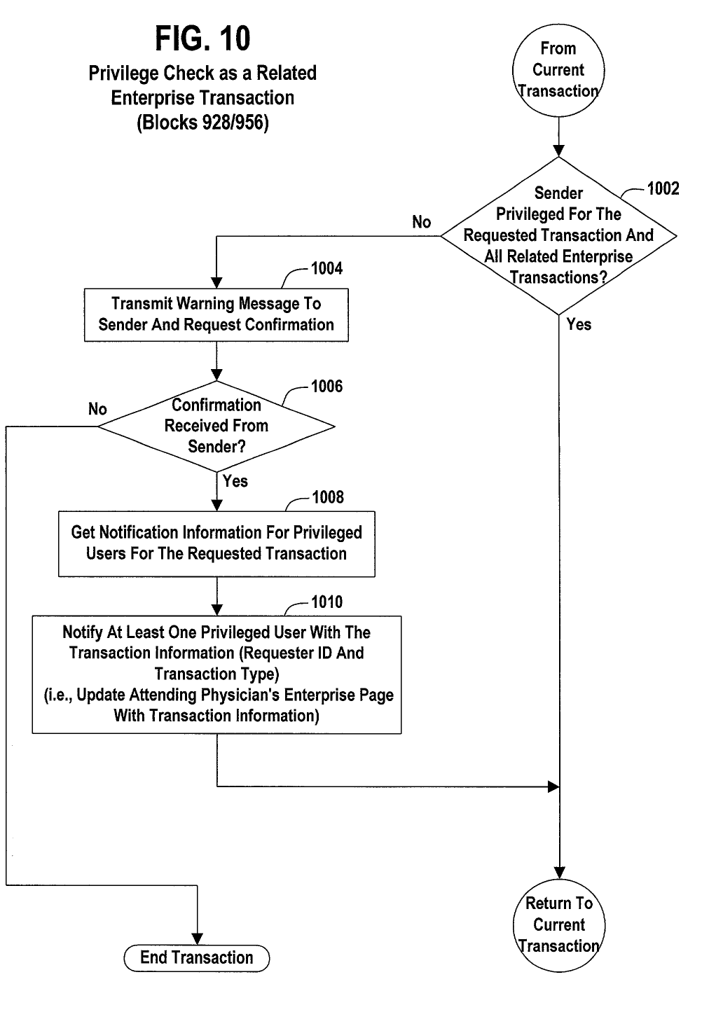

Alternatively, direct communication between enterprise server 530 and any of ancillary systems 502-510 may be accomplished through the use of requests for block data transfers. Block transfers of data are especially useful when enterprise data errors have been discovered in the enterprise database due to an invalid HL7-to-enterprise data-mapping table being employed by AIG catcher 520. Enterprise database restoration and block transfers of data from ancillary systems 502-510 within enterprise network 500 will be described in greater detail with respect to FIG. 10 below.

Web server 540 presents users with an easy to use, intuitive HTML-based interface that is homogeneous across all ancillary system platforms. This is accomplished using hyperlinked enterprise HTML web pages. As mentioned above, web server 540 handles all application operations between browser-enabled web clients 544A-544N and the back-end enterprise applications executed by enterprise server 530. Enterprise requests are normally initiated by a user performing an action on an enterprise web page. For example, by clicking a hyperlink (a hot spot such as an icon, image portion or highlighted text), dragging and dropping text or icons, or entering a character value in a text field. The request is routed to web server 530 using HTTP over the Internet as an HTML page. In response, web server 540 converts the HTML request to an enterprise message and passes that message to enterprise server 530. There, the enterprise application processes the message transaction, including any related transactions, and formulates an enterprise response for web server 530. Enterprise server 540 then sends the enterprise response message to web server 530 which writes the response data in the appropriate fields in a suitable enterprise web page. Web server 530 then transfers the web page to the user's browser over the Internet via HTTP. The user views the requested enterprise information as an HTML web page using a browser.

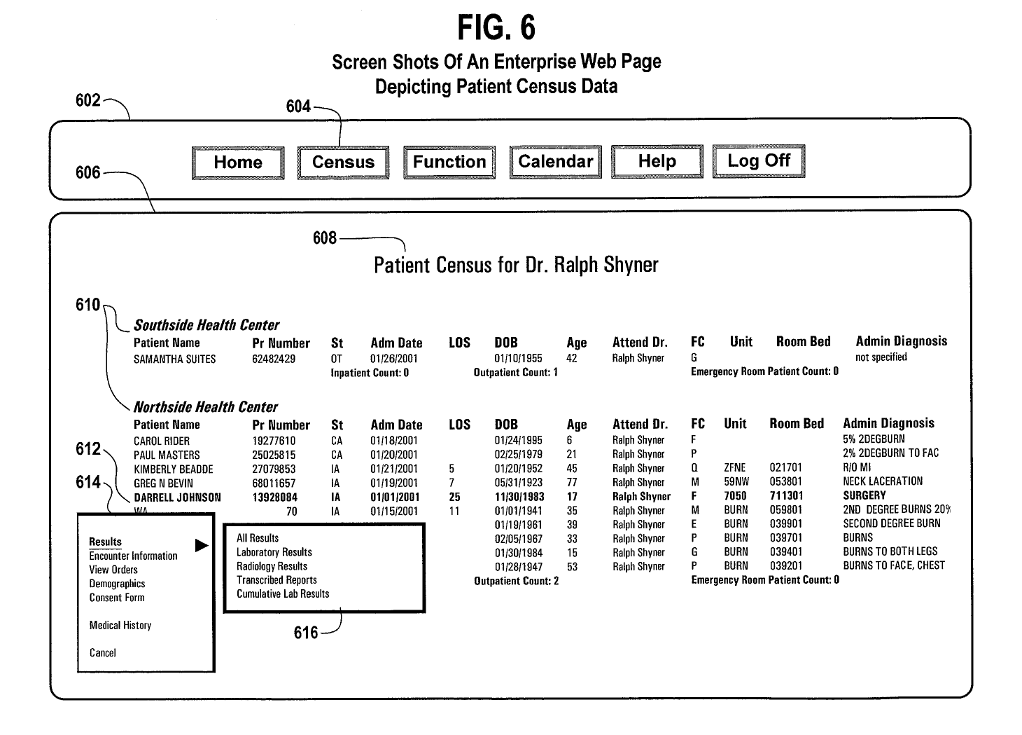

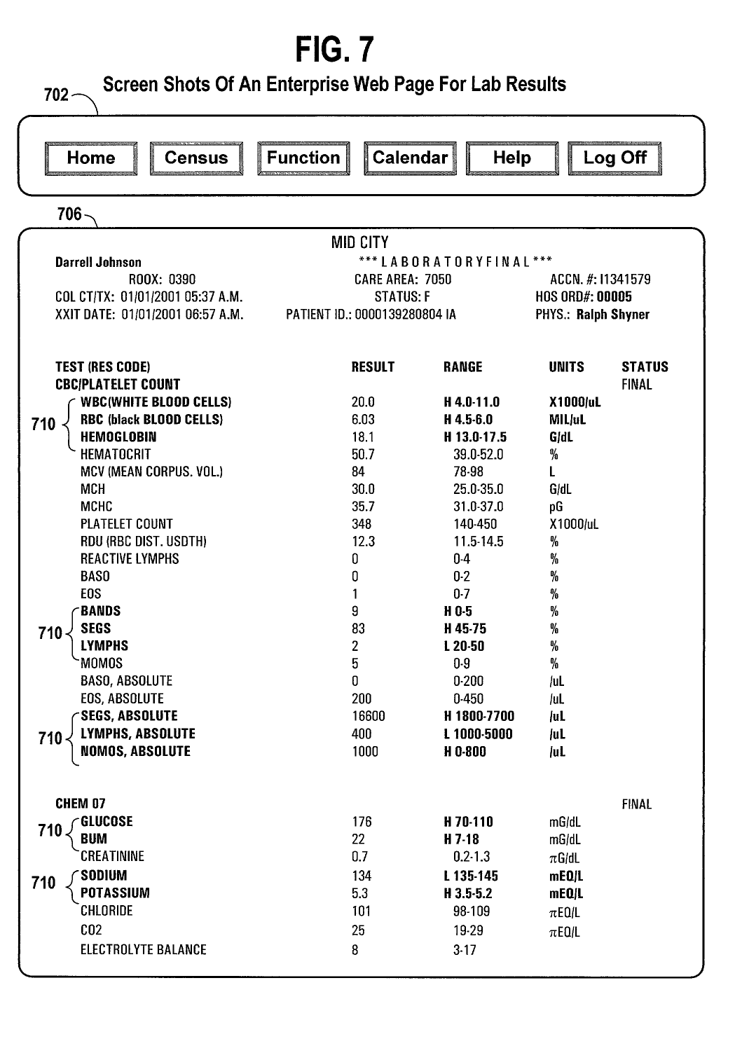

FIGS. 6 and 7 depict exemplary screen shots of enterprise web pages containing user specified enterprise data in accordance with an exemplary embodiment of the present invention. FIG. 6 is an illustration of patient census information for Dr. Ralph Shyner, from the example used above. The web page may be fashioned in any of a number of manners using a number of well known display (Graphical User Interface GUI) techniques. A mouse, keyboard or other pointing device is used to navigate through the enterprise web pages. In the depicted example, the web page is divided into two parts, functional window 602 containing enterprise functionality and enterprise information display window 606. Functional window 602 contains executable screen buttons for executing generic enterprise functionality of Home (navigational), Census, Functions (other enterprise functions), Calendar, Help and Log Off. Here, the user has logged in and been authorized by web server 540 and privilege checked for the user ID by enterprise server 530. With respect to the depicted example, the user previously selected Census 604 for accessing patient census data and that data is now displayed in enterprise information display window 606. The patient census information is selected for the user based on the user's ID, here Patient Census for Dr. Ralph Shyner 608 has been retrieved by enterprise server 530 from enterprise database 532 and displayed. Observe that in this case, the enterprise comprises both the Southside Health Center and the Northside Health Center and so the enterprise application has returned enterprise patient census data 610 for both. All of Dr. Shyner's patients currently admitted to either facility are displayed on an enterprise information display window 606 of the web page. In accordance with an exemplary embodiment of the present invention, enterprise web pages are built with hypertext links to other documents on enterprise database 532 or even to other locations on the web using HyperText Markup Language (HTML) or EXtensible Markup Language (XML) tags, or codes, embedded in the text. HTML defines the page layout, fonts and graphic elements as well as the hypertext links to other documents located anywhere that the web client can access. Each link contains the Uniform Resource Locator (URL), or address, of a web page residing on the same server or any server worldwide. Any data displayed on any web page that has a relational data in the enterprise database contains an executable link for retrieving that data. In the depicted example, the patient identifier “Darrell Johnson” 612 has been selected causing menu box 614 to open for accessing other enterprise functionality and information related to the elected patient identifier. Menu box 614 contains hot spots associated with the executable text commands in menu box 614—those commands include, “Results, Encounter Information, View Orders, Demographics, Consent Form, Medical History and Cancel. The command “Results” has been selected by the user prompting the opening of a second box, menu box 616 which contains enterprise data and functionality selections related to “Results.”

FIG. 7 is an illustration of lab results displayed on Dr. Shyner's web page as a result of the doctor selecting the “Laboratory Results” command in menu box 616 of FIG. 6 in accordance with an exemplary embodiment of the present invention. The laboratory results displayed in enterprise information display window 706 contains only laboratory data related to “Darrell Johnson.” The enterprise applications arranges and highlights the enterprise data in such a manner that the user can quickly assimilate the data. For example, in accordance with an exemplary embodiment of the present invention, the enterprise application retrieves relationship rules for the type of enterprise data being received, or in this case, requested. Here, the relationship rules relate to the manner in which the laboratory results are displayed for the user-requester. Usually, testing range data accompanies each laboratory test in the HL7 message from the ancillary system (the laboratory), the range data that specifies the normal range for test values. That range data is used by the enterprise application for comparing the actual laboratory test value. If the actual laboratory test value falls within the range, that value is displayed normally, i.e. as regular black text font. If however, the actual laboratory test value falls outside the range specified in the HL7 message, then that value is displayed as highlighted text, i.e. as highlighted, colored, bolded, etc. Laboratory test values 710 fall outside the normal ranges and therefore, are highlighted. In practice, actual laboratory test values and the normal range for that test are transferred to and stored in enterprise database 532. When the laboratory test values for a patient are requested by a user, the enterprise application retrieves relationship rules for the laboratory test data along with the actual laboratory test values and the normal range for that test. Then, based on the enterprise relationship rules, the actual laboratory test values are compared to the respective enterprise laboratory test range data prior to sending the data to the web server. Next, based on the outcome of the comparison, the enterprise application can add an HTML tag or merely change an HTML display attribute associated with the test value.

In accordance with still another exemplary embodiment, the enterprise laboratory test range data is modifiable, within limits, by a user with privilege for the particular patient. Then, the actual laboratory test values are compared to the respective enterprise laboratory test range data prior to sending the data to the web server. This feature allots a measure of flexibility to a care provider for the provider's patients. Individual patients can be more carefully monitored for changes in critical test data, while less critical test laboratory test data values can be de-emphasized. Permitting a care provided to resets range data values, within reasonable limits, keeps the care provider responsive to the test results. Whenever patient laboratory results are received by the enterprise sever, the responsible care provider is notified, usually the attending physician. Normally, the care provider's web page is modified such that the care provider easily recognizes from the web page that laboratory test results have been received. If, on the other hand, the laboratory results contain test values that are outside the acceptable range for a specific laboratory the test, then an additional message is sent to the care provider, via telephone, pager, etc. The care provider knows or is instructed to access the enterprise web page for the laboratory test values. The problem with this method is that many times, the care provider is unnecessarily interrupted for test results that do not need to be immediately dealt with. By allowing the care provider to reset some laboratory range values, the care provider decides what an acceptable range is for a particular laboratory test. If the care provider knows that a particular patient's laboratory results will not be within the normal range for that test, then there is no reason for a special notification unless the results are exceptionally skewed. Thus, the care provider is not bothered unless, as prearranged by the care provider, the results are in the range that need immediate attention. Any other laboratory test results are retrieved by the care provider from the provider's web page in the normal manner.

Returning to FIG. 5, one feature of the present enterprise system is that enterprise database 532 maintains a copy of all event data processed by any one of disparate, ancillary systems 502 to 510. An enterprise user can, therefore, access system level event data without understanding the particular ancillary system interfaces and applications.

Turning now to FIG. 8, a flowchart depicting a process employed by the AIG catcher for converting HL7 messages to enterprise messages. As discussed above, a primary function of the AIG is to redirect each HL7 message it receives to one or more ancillary systems listening for that particular message. While the functionality of various vendor's AIGs differ, it is generally understood that a AIG can, if need be, restructure HL7 messages based on one or more messaging specifications adopted by the ancillary systems. In addition, it is the responsibility of the AIG to reroute an incoming HL7 message to one or more ancillary systems based on the message and/or event type. Recipient systems must acquire and maintain a set of vendor-specific data rules for each vendor's message for which it is listening, hence, making sense of the data elements inside the HL7 message body is largely the responsibility of the receiving ancillary system. Therefore, converting an HL7 message to an enterprise message involves two distinct processes: converting vendor-specific message data into enterprise-specific data and then formatting the message structure to the enterprise messaging protocol. Recall that the present description assumes that the AIG catcher and the enterprise server are separate physical network elements, if, on the other hand the functionality of the AIG catcher resided within the enterprise server, then it might not be necessary for the AJG catcher to reformat the message structure to the enterprise messaging protocol. Under certain conditions, usually in situation where the AIG catcher is a logical function performed by the enterprise application, an enterprise message need not be generated by the AIG catcher. In accordance with that scenario the contents of the HL7 message are to merely converted from vendor-specific message data into enterprise-specific data and then immediately stored within the enterprise database. However, in other situations the AIG catcher converts vendor-specific message data into enterprise-specific data and then formats the message structure to the enterprise messaging protocol for transmission among the enterprise system or internally, within the enterprise server. The functionality of the AIG catcher will be better understood with reference to the description of FIG. 8 below.

An AIG catcher is provided in accordance with the preferred embodiment of the present invention for converting vendor-specific message data to enterprise-specific data and then formatting the message structure to the enterprise messaging protocol. The process begins with the AIG catcher receiving an event triggered HL7 formatted message from the AIG (step 802). Of course, the message was originally generated by one of the vendor applications on its ancillary system. The AIG catcher first unwraps the message (step 804) and then identifies the message type and event types (step 806). The vendor application that processed the event is determined from the message and event type. A vendor-specific HL7-to-enterprise data-mapping table is then retrieved from the AIG database (alternatively from the enterprise database) for the event processing vendor application (step 808). Each segment field within the HL7 compliant message may, but does not necessarily, contain a value for an HL7 compliant data element value (including a null value). Alternatively, based on the HL7 specification, certain segment fields may omit a data element value altogether. Whether or not the vendor application actually enters a data element value in a particular segment field is a function of one of the HL7, auxiliary and proprietary messaging specifications. Thus, by using the vendor-specific data-mapping table, which is formulated from the HL7, auxiliary and proprietary messaging specifications, the existence of a value for a particular segment field can be determined for any type of HL7 message. Alternatively to the description immediately above, and as briefly alluded to previously, the AIG catcher itself may contain translation data and handling logic in code for converting vendor-specific HL7 data to enterprise data. In that case the AIG catcher code itself would supply the necessary message mapping conversion data and no vendor-specific HL7-to-enterprise data-mapping table would exist in either the AIG catcher database or the enterprise database.

Vendor-specific data element values are then converted to enterprise-specific data element values in an iterative process of accessing, identifying and converting values in each segment field of the HL7 message to enterprise data element values in an enterprise message, one segment field at a time. The process begins by parsing a next message segment (step 810) and a data element from the next segment field holding a value (step 812). Then, the vendor-specific data element value contained in that segment field is transformed to an enterprise-specific data element value in an enterprise message using the vendor-specific data-mapping table (step 814).

Once this is accomplished, the process continually iterates through the entire group of data fields held in the segment until the last data field has been processed (step 816). At that point, the AIG catcher determines whether the message contains another segment (step 818). The message is then checked for another segment (step 818), if one exists, the process reverses to step 810 where that message segment is parsed out and the process of converting each vendor-specific data element value is converted and inserted into an enterprise message. Returning to step 820, at some point, each of the message segments have been processed and the AIG catcher transmits a message to the enterprise data server (step 820). The message conveyed to the enterprise server is no longer defined by the vendor-specific messaging rules, but is now defined by enterprise-specific messaging rules. Thus, once received by the enterprise server, the message transaction can be processed by the functionality of the enterprise server.

Below is an exemplary data flow for ADT-A01 transaction processing (admit a patient). Here it should be noted that the description assumes that the functionality of AIG catcher 520 is contained within enterprise server 530 and the information on vendor specific mapping tables 522 is actually stored on enterprise database 532. Initially, AIG catcher 520 receives record from AIG 512 for an A01 transaction and places data into temporary storage tables on enterprise database 532, these include:

TempPart—is a temp storage table containing patient (participant) specific information common to all A01 and A08 records;

TempPartInsurance—is a temp storage table containing patient insurance information for the current encounter (hospital visit)—common to all A01 and A08 records; and

TempSuperRecA01—encounter specific information specific to A01.

AIG Catcher 520 then executes stored procedures (“SQL scripts” on enterprise database 532) based on the record type (A01, A08, etc.). These procedures are responsible for populating a single table with the data from the current temporary table. Below are exemplary scripts and functionality:

spParticipantFullA—This procedure populates the Participant table with participant data from the TempPart table.

spParticipantFullA—This procedure populates the Participant table with emergency contact and guarantor data from the TempPart table.

spInsurance—This procedure populates the Insurance table with insurance data from the TempPartInsurance table.

spEncounterA01—This procedure populates/updates the Encounter table with encounter data from the TempSuperRecA01 table.

spEncoutDocsA01Adm—This procedure adds the admitting doctor from TempSuperRecA01 to the EncountDocs table for this encounter.

spEncoutDocsA01Att—This procedure adds the attending doctor from TempSuperRecA01 to the EncountDocs table for this encounter.

spEncoutDocsA01Ref—This procedure adds the referring doctor from TempSuperRecA01 to the EncountDocs table for this encounter.

spCensusA01—This procedure populates the Census table, if needed.

spSpecialCasesA01—This procedure handles special cases when processing A01 records such as populating other physicians related to the Encounter into the EncountDocs table in addition to the Admitting, Attending and Refereeing Doctors.

spCleanA01—This procedure copies the data from the temp tables to log tables and deletes the temporary record.

The following is a sample SQL script for the procedure spParticipantFullA:

[image]

[image]

[image]

[image]

[image]

[image]

[image]

[image]

[image]

[image]

[image]

[image]

[image]

[image]

In the prior art, disparate ancillary systems automatically generate a message in response to a realized trigger event. The message might be received by a number of ancillary systems, which processed the identical message data differently based on the constraints of the particular ancillary application that received the message. Each message transaction would then be processed by rules established by the individual receiving application without regard to any other ancillary system. Therefore, any time it is necessary to obtain an enterprise solution, a user was forced with the task of accessing one or more disparate, ancillary system databases using the unique rules of that application for drilling down into the database for the necessary information. However, any information obtained in this manner was always presented as system-level information. Enterprise-level answers required a user to access one or more disparate, ancillary systems for system-level data for a particular enterprise department and then convert that system-level information to enterprise-level data by using a series of enterprise-level rules. Therefore, even though information contained in the disparate, ancillary system databases could be used for deciphering an enterprise-level solution, the solution could not be reached without applying enterprise-level rules to the system-level information.

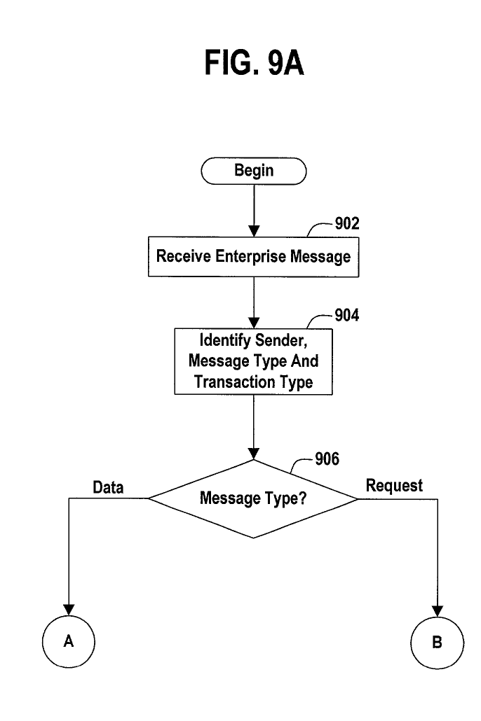

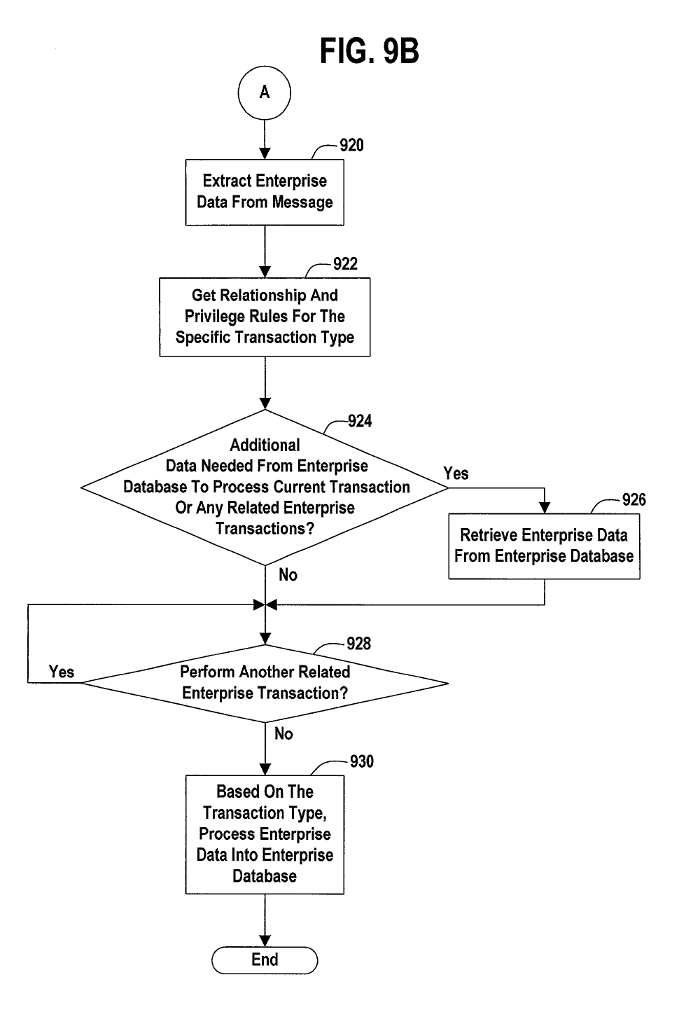

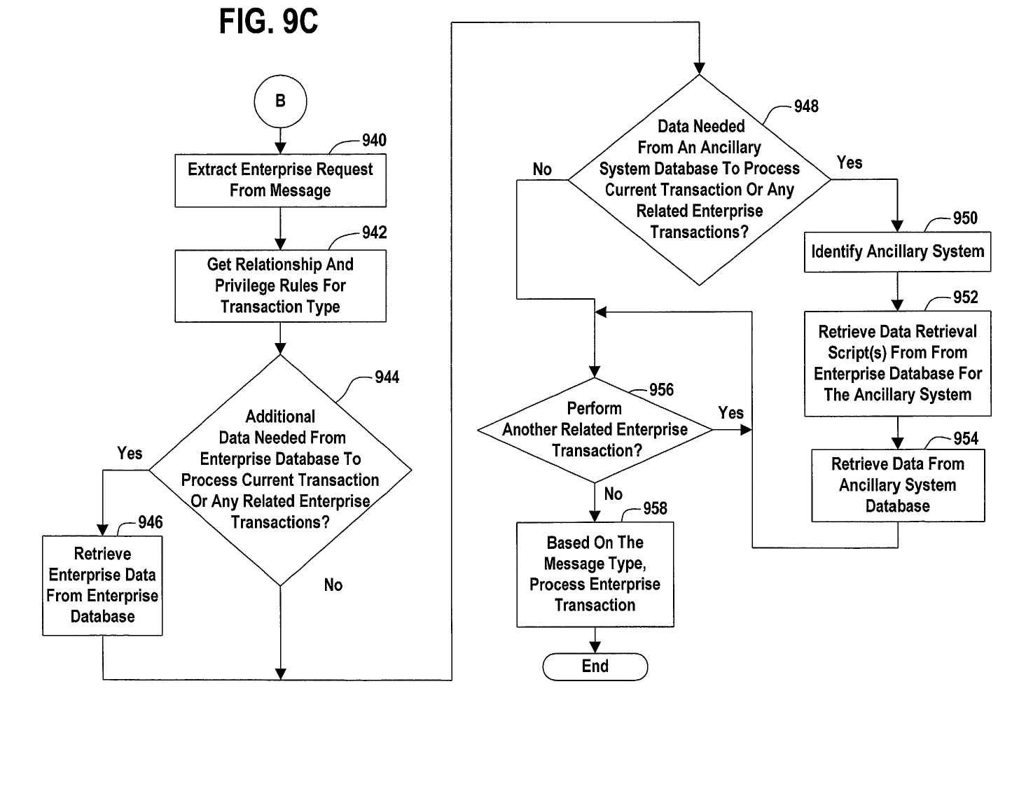

In an effort to alleviate the shortcomings of the prior art, a method for processing enterprise-level transactions is described where enterprise-level data is processed by enterprise data relationship rules in accordance with the preferred embodiment of the present invention. FIGS. 9A to 9C depict flowcharts for describing a process for executing message transactions as performed by the enterprise server in accordance with an exemplary embodiment of the present invention. The process begins with the enterprise server receiving an enterprise message from, for example, the AIG catcher (step 902). As discussed above, the enterprise compliant message may have originated from any one of the disparate, ancillary systems via a conversion at the AIG catcher or any one of the pluralities of web clients that are functionally connected to a network served by a web server. Once the enterprise server receives a message, the server immediately identifies the message and transaction type from the message header (step 904). For the purposes of the discussion herein, message types might be broken into two distinct groups-data and request messages. Each are processed somewhat differently and thus, will be described using separate paths in the depicted flowchart. It should be understood, however, that the depicted flowchart is merely exemplary and any number of routine paths might be followed without being separated from the intended scope of the present invention. Therefore, prior to processing the message transaction, the enterprise application identifies the message type (step 906).

Assuming that the message received by the enterprise server is a data message, the process flows to FIG. 9B, where the enterprise application extracts the enterprise data from the message (step 920). Next, the enterprise server accesses its database for relationship and privilege rules based on the data and transaction types. Privilege rules are also based on the requester's ID. Here, based on the relationship rules, the enterprise application may perform supplemental enterprise transactions other than the enterprise transaction requested by the sender. In order to process the requested transaction, or one of the related enterprise transactions, the enterprise server may require additional data from the enterprise database. Hence, based on the relationship and privilege rules, the enterprise application determines whether additional data is needed from the enterprise database to process either the current transaction or any related enterprise transactions (step 924). If additional enterprise data is needed, the enterprise application retrieves the data from the enterprise database (step 926).

In accordance with other exemplary embodiments of the present invention the data tolerance values are available from the received HL7 message along with the actual test values. The rules that get applied are enterprise specific such that the enterprise has decided if the result is “HIGH” or “LOW”, it will notify in one manner such as a flag in the enterprise database and application as “ABNORMAL”. Additionally, the enterprise has decided that if the result is “CRITICALLY HIGH” or “CRITICALLY LOW”, it will then notify the enterprise in the form of flagging the record in the enterprise database and application system as “PANIC” Further, “PANIC” value results get higher order precedence in the sorting and display on screen.

The process then flows to step 928 where the enterprise application determines whether related enterprise data is necessary for processing one of the enterprise transactions. If, at step 924, it is determined that no further enterprise data need be retrieved from the enterprise database, the process flows directly from step 924 to step 928, where the enterprise application performs any enterprise transactions which may be related to the requested enterprise transaction. Supplemental enterprise transactions include performing functionally related transactions, such as scheduling technicians and checking related tolerance rules (see the respiratory therapy example above and laboratory data example below) or privilege checking (see also the privilege checking example below).

In the case of a data message, data is being conveyed to the enterprise database from one of the ancillary system applications. Here, an exemplary supplemental enterprise transaction might be, with respect to laboratory data, the comparison of laboratory test data values for a patient to predefined tolerances for the specific laboratory tests. In that case, at step 920, the enterprise application would extract specific laboratory test values from the message. At step 922, the enterprise application would automatically retrieve relationship rules regarding those particular kinds of tests. From those relationship rules, the enterprise application would understand that certain predefined parametric data values must be acquired from the enterprise database for the specific laboratory test data contained in the message (step 924). The enterprise application would retrieve the predefined data tolerance values for the laboratory test values in the message (step 926). With respect to the laboratory data it received, the enterprise application would then perform a series of related enterprise transactions of which, one of those transactions would be comparing the actual laboratory data for the specific tests received at the enterprise application with the predefined tolerances for those values. If the data values received by the application are within the tolerances stored in the enterprise database, then no further action is required by the enterprise application. If, on the other hand, however, the laboratory test values received by the enterprise application exceed the predefined tolerances stored in the enterprise database, then the enterprise application automatically performs a series of other related enterprise transactions. Those transactions may be to access the patient's attending physician's notification information and then automatically transmit a warning to the attending physician that the patient's lab results do not fall within the normal tolerance for the patient.

Alternatively, or in addition, the enterprise application may also access patient information, such as the patient location within the care facility, then determine the patient's nurse's station and then transmit a warning to the nurse's station that the laboratory results for the particular patient do not fall within the predefined tolerances for that particular lab test. The warning notification to the nurse would be in the form of the record being flagged as “abnormal” or “panic” in the display of all results for this patient, or in the display of all patient results for the unit. By merely posting a message to the attending physician's or nurse's station's enterprise web page describing the problem with the lab results received by the enterprise system, the enterprise application can notify the attending physician and/or physicians within the attending physician's group and/or the patient's nursing station.

Returning to FIG. 9B, once all of the related enterprise transactions have been completed in step 928, the requested transaction type can then be processed (step 930). In this particular case, the requested transaction type to be processed is a data message. Enterprise data from the message is then entered into the enterprise database in accordance with the transaction type. For example, the transaction type might be entering new data element values, in which case, the enterprise database allocates new data fields for the new data element values contained in the message. In other cases, the information may be updated information—where previously created data fields in the enterprise database are merely updated with the new data values and may include information that was lacking from the previous message. For example, at the time of admission, certain patient information from the PID segment may not have been available; however, even though some did not contain an actual data value when the original PID message was sent, the enterprise database created data fields for all data types in the PID segment. Processing an updated data transaction merely involves the enterprise application supplementing an original message value with updated values. The enterprise application then enters the updated information in an appropriate data field, which was previously created for the enterprise data. At that point, the process ends.

Turning again to step 906, if the message is not a data message, then the message is a request message and the enterprise application will process the message transaction by performing a request enterprise function. In that case, the process flows to FIG. 9C, which is an exemplary process showing the enterprise application's handling of a request transaction. The request is initially parsed from the message (step 940). Similar to processing a data message, the enterprise application retrieves relationship and privilege rules for the particular message and transaction types from the enterprise database. Next, the enterprise application determines whether additional data is needed from the enterprise database to process either the current (requested) transaction or any transactions that are related to the requested transaction (step 944). If additional data is needed from the enterprise database, the enterprise application retrieves the data (step 946) and the process flows to step 948. Turning to step 944, if no additional data is needed from the enterprise database, the process flows directly to step 948, where the enterprise application determines if any system-level data is needed from one or more of the ancillary system databases to process the current transaction or to process any related enterprise transaction to the requested transaction.

The need for system-level data from one of the disparate, ancillary systems is generally limited to the replacement of data contained within the enterprise database. Although, the enterprise application can access data housed in an ancillary system directly, provided the data in that ancillary system is accessible and stored in a manner that is conducive to the enterprise system's use. Often, it is unlikely that any data will be needed from an ancillary database. Cases where a data error has been discovered in the enterprise database is the exception, i.e. where enterprise data has been erroneously entered within the enterprise database. Most often, errors in the enterprise database are the result of inaccuracies in one or more HL7-to-enterprise data-mapping tables stored in the AIG catcher's database. If entries in the vendor-specific data-mapping table have not been properly updated to reflect changes in vendor-specific messaging definitions, then all data received from that particular ancillary system must be considered compromised, which was received after the change was implemented by the vendor. One exemplary embodiment of transferring data from an ancillary system takes advantage of the block transferring feature of the HL7 standard. However, ever few, if any, vendors have coded their ancillary systems to receive and, in turn, handle a request from a foreign system for a block transfer of data.

Initially, the ancillary system on which the error occurred must be identified (step 950). Next, the enterprise application accesses data retrieval scripts from the enterprise database that are specific to the identified ancillary system(s) (step 952). It is important to recognize that the data retrieval scripts provide all of the functionality necessary to drill down into an ancillary database, identify the requested data, retrieve the data and then convert the requested ancillary system-level data into enterprise-level data. Using the scripts, the enterprise application can access the identified ancillary system's database and retrieve data from that database (step 954). Next, the enterprise application performs any related enterprise transactions to the requested transaction (step 956). It is expected that block transfers of data from one of the ancillary system databases do not invoke identical related enterprise transactions in the same manner as event triggered data. Event triggered data from the AIG catcher is temporal, acquired in near real-time, and initiates all temporally related enterprise transactions to be immediately performed by the enterprise application. On the other hand, data received from one of the ancillary databases is usually a block of non-temporal data. Any related enterprise transaction processing would, therefore, be limited to non-temporal transaction functions, such as updating enterprise web pages with the new data. Thus, warning messages and notifications being sent to attending physicians and nursing units are no longer appropriate as the requested data cannot be considered temporal.

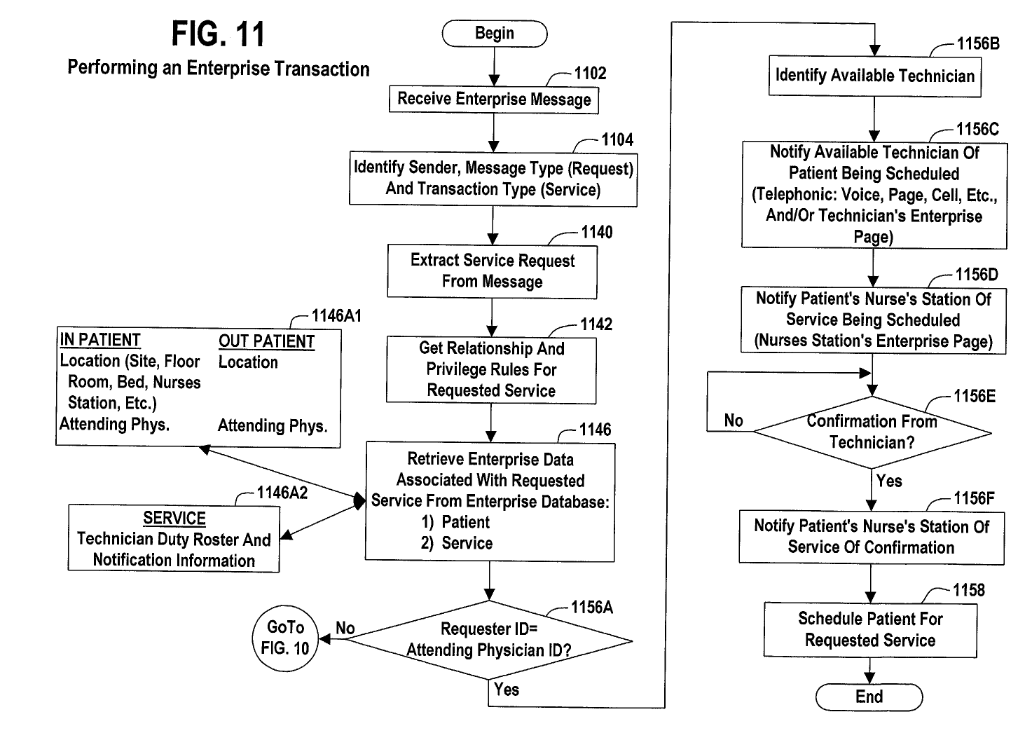

Alternatively, from step 948, if it is determined that no additional data is necessary from an ancillary system, any enterprise transactions that are related to the requested transactions are performed (step 956). Again, the enterprise application performs enterprise transactions related to the request and/or additional data retrieved from the enterprise database. Examples of related enterprise transactions include privilege checks, which will be described thoroughly with respect to FIG. 10, and related scheduling transactions described with respect to an exemplary enterprise transaction in FIG. 11. Finally, after the related enterprise transactions are processed, the enterprise application processes the message request (step 958) and the process ends.

In accordance with another embodiment of the present invention, the enterprise system is augmented with privilege rules for determining enterprise privileges bestowed on a user. Enterprise privileges refer to the rights granted to a user by the enterprise to act for the enterprise on a matter concerning the enterprise. With respect to the health care example, privileges loosely correlate to hospital privileges granted to a physician or employee by a hospital or care facility. Enterprise physicians are concerned that patient care will suffer whenever a patient is treated by a physician who is not familiar with the patient's medical history and the patient's own particular idiosyncrasies. Therefore, the enterprise is best served by allowing only physicians who established a privilege with a patient to provide care for that patient. On the other hand, the enterprise is aware that there may be cases where the patient's immediate well-being rises above the need for a rigid privileges system. Sometimes, situations arise that require immediate attention from a physician who has not been granted privileges for the patient for instance, an emergency room physician. There is also the practical reality that physicians sometimes temporarily trade responsibilities for patients without notifying the necessary hospital administrators. Having a rigid, inflexible privileges system might diminish the quality of care to a patient by denying a physician, who may otherwise be authorized to particular information, access to that information based on privilege. In accordance with an exemplary embodiment of the present invention, the exemplary privilege rules involve further limiting an authorized user of the enterprise system based on privilege. However, privilege rules are layered over system authorization rules therefore, in most cases, if a user has been authorized, that user will be granted access to enterprise data and functionality to which the user is not privileged.

Privilege rules may be contained in the enterprise database or in an independent database that is separate and apart from the enterprise server and storage and the enterprise database. As a practical matter, however, the privileges database is incorporated in the enterprise database and the functionality necessary for supporting the privilege functions is easily supported by the enterprise server. On the other hand, system and network security may be supported by either the web server or the enterprise sever or both.

Once established in the enterprise, the privilege system, in accordance with an exemplary embodiment, allows users with privilege to freely view enterprise information, schedule enterprise events, or utilize other enterprise functionality. However, if an authorized user attempts to utilize the enterprise system in any manner in which the user does not have the privilege, the user is first warned of the infraction, then queried for intent and upon completion of the query, granted limited privilege to the enterprise functionality. The query includes a request for an acknowledgment from the user that the user intends to utilize the enterprise system in a manner that the user is not privileged. The user may also be requested by the enterprise application to state the reason why access to the records is necessary and/or to re-enter the user ID and password. However, once the user makes the conscious decision to use enterprise functionality to which the user has not been formally granted the privilege, the enterprise system creates a record of the infraction and automatically notifies one or more users which have established a formal privilege.

Returning to the example of a physician in a health care facility, prior to executing a request from a physician, the enterprise application first determines whether or not the physician has been granted the privilege for the requested enterprise functionality. With respect to a request involving a patient, the enterprise server accesses the patient's admission information in the enterprise database. Remembering that patient information is stored on the enterprise database from event trigged messages transmitted from one or more of the disparate, ancillary systems, such as the Medical Records system, the enterprise server retrieves the identity of the attending physician from the patient's admission information. The enterprise server then retrieves additional data necessary for completing the privilege transactions. For example, accessing the identities of physicians who have been granted patient privileges for that particular patient. These physicians either have some preexisting relationship with the attending physician that automatically conveys privileges or merely have been granted privileges to this patient by the attending physician. Privileges may arise from attributes, such as being identified as a members of the attending physician's staff, or being identified as enterprise personnel needed for performing enterprise services, etc. If the enterprise application cannot confirm that a physician has been granted privilege, the enterprise application first visually warns the physician by questioning the physician's intent. At this point, if the physician has merely made an error, the requested transaction can be terminated without writing a record of the encounter. However, if the physician indicates that the intent is to actually perform a function to which a privilege has not been established, the enterprise system confirms this intent by requesting further information from the physician. In accordance with one embodiment of the present invention, the care provider (physician, clinician, or other caregiver) must specify a reason for accessing the record before being granted access. Since the care provider is already authenticated to the enterprise application, it is aware of the care provider's name, user ID, password and related data from the physician database. This data is then logged where appropriate. In an alternate embodiment, the user ID, password, address, etc. could be incorporated into the required authentication. That information is checked by the enterprise application against the physician information in the enterprise database and once verified, the physician is granted temporary privileges to the enterprise functionality.

Immediately upon notification by the user of the intent to utilize the enterprise functionality in a manner inconsistent with the user's privilege, the enterprise system prepares to notify the responsible care provider. Normally, the enterprise system notifies the attending physician of the privilege transgression via the attending physician's HTML page on the enterprise system. However, in accordance with an alternative embodiment of the present invention, the attending physician may also be alerted by telephone with a “canned” voice message or by paging the attending physician from telephone numbers stored on the enterprise database for the attending physician. The attending physician is then in the position to take whatever action is necessary.

Referring now to FIG. 10, a flowchart is shown depicting an exemplary process for privilege checking that may be performed by an enterprise application in accordance with an exemplary embodiment of the present invention. As discussed above, a privilege check is generally considered a related enterprise transaction that is processed in addition to any requested enterprise transaction and is normally performed at either blocks 928 or 956 of FIGS. 9B and 9C. Remembering that at steps 922 and 942 in FIGS. 9B and 9C, respectively, the enterprise application has already acquired the privilege rules needed for the transaction type. At steps 926 and 946, the enterprise application has retrieved any enterprise data necessary for processing the enterprise rules as related to the presently requested transaction. Thus, the enterprise application has already acquired the necessary enterprise privilege rules and additional enterprise data to perform a privilege check on the current request.

The privilege checking process begins with the enterprise application in possession with all the necessary information for a user privilege check. The sender, or requester, is then checked for the privileges necessary to perform both the requested enterprise transaction and all related enterprise transactions to the requested transaction (step 1002). Here, the enterprise application may check additional enterprise data, such as admissions records for the patient, for an attending physician or a list of privileged physicians. As discussed above, in accordance with an exemplary embodiment, strict rules for access to patient data are maintained by the enterprise system. Privilege is based on the care provider's relationship to a patient. A specific care provider must be listed in a particular enterprise field that indicates privileges to the patient. For example, a physician must be either the admitting, attending, referring or consulting physician in order to access the patient record. In another example, a nurse must be working on the unit where the patient is currently admitted, etc. No one user can “grant” access of patient data to another user as no one user really “owns” the data. The enterprise “owns” the data. Therefore, in addition to retrieving the identity of the attending physician for the patient, the identities of all physicians that the enterprise rules grant access are also retrieved. Again, the retrieval of this information has been performed prior to making the privilege determination. Those identities (or user IDs) of privileged users for the particular transaction, are then compared against the identity of the requester. If, at step 1002, a match occurs, the requested transaction is immediately preformed by the enterprise application in a normal fashion and the process returns to the current transaction.

If, on the other hand, at step 1002, a match between the requestor ID and the identity of a privileged user is not found, then the enterprise application proceeds on the assumption that the requestor does not have the privilege for the requested enterprise transaction. In that case, the enterprise application first transmits a warning to the sender and requests confirmation of the requestor's intent to the transaction (step 1004). At that point, the enterprise application waits for a confirmation from the user (step 1006). If the user session times out without a confirmation response from the user, the requested transaction ends without executing the transaction. If, on the other hand, the user confirms the intent to perform a transaction to which the user is not privileged, the enterprise application accesses the privilege user's notification information from the enterprise database for the requested transaction (step 1008). Again, it is expected that the enterprise application has previously retrieved notification information for all privileged users prior to performing the privilege check thus, step 1008 may be omitted. The enterprise application then notifies one, or all, of the privileged users that a user without privilege has requested a transaction for which the requestor has no privilege (step 1010). The enterprise application transmits all pertinent information concerning the transaction to the privileged user, such as the requestor ID, the transaction type, patient information, etc. The notification is displayed on the privileged user's enterprise page, for instance, as an update to attending physician's enterprise page containing transaction information. The attending physician can then take any appropriate action. Once the notification has been transmitted, the enterprise application returns to processing the current transaction.

In accordance with an exemplary embodiment, the present invention establishes relationships between seemly disparate event information and enterprise data that could not be recognized by analyzing the event data at a system level. In one health ISS example, a trigger event occurs, such as a patient being admitted, which populates the ADT (admissions, discharge and transfer) database and causes an HL7 compliant message to be transmitted to the AIG socket. The AIG catcher uses a vendor-specific HL7-to-enterprise data-mapping table to convert the HL7 message data to an enterprise message and sends that message to the enterprise server. The enterprise application then performs the requested enterprise transaction, entering the patient admission on the enterprise database in the appropriate fields based on the message type. Prior to performing the requested enterprise transaction, however, the enterprise application also retrieves any enterprise relationship rules for the transaction and any additional enterprise data for processing the requested enterprise transaction or any related transaction. In the case of a patient being admitted, by updating the enterprise census web page for the nurse's unit with patient admission information, the enterprise application might notify the nurses responsible for caring for the patient of the patient being admitted.

In another example, a care provider (physician) prescribes a course of respiratory therapy for the patient, causing a trigger event to occur at one of the ancillary systems—the Order Entry component of the hospital information system. In accordance with an exemplary embodiment of the present invention, a physician's order prescribing respiratory therapy for a patient is received as a “request for enterprise server” type of message transaction by the enterprise server. The enterprise application accesses patient information, respiratory therapy duty roster and therapist notification information stored in the enterprise database. Prior to actually processing the physician's service order transaction, the server application locates the patient's assigned floor, room and bed and identifies the therapist and nursing unit assigned to cover the patient's room and bed. The enterprise application notifies both the appropriate therapist and nursing unit of the pending enterprise request and only then does the enterprise application process the physician's request transaction. Therefore, rather than merely creating a scheduling record to be stored in the enterprise database, the enterprise application intelligently schedules the patient by performing all enterprise transactions that are related to scheduling a patient for respiratory therapy.

In accordance with an exemplary embodiment of the present invention, intelligent scheduling is also possible. The enterprise application first determines which respiratory therapist is on call for the patient's room from a duty roster. Next, the enterprise database server might then perform more advanced scheduling functions such as checking the nominal time requirement for performing the requested respiratory treatment service and then checking the respiratory therapists' schedules for an open block of time sufficiently long enough to perform the treatment. The enterprise application may also perform scheduling management functions such as not scheduling a therapist to a time that would result in an open time period that is too short to schedule another type of respiratory service. An intelligent scheduler may also load manage between therapists to reduce incidences where one therapist is solidly booked and another is only lightly booked. In those cases, the scheduler may also consider the physical layout of the facility or the therapist's driving distance and include transit time into the scheduling process.

In practice, however, many hospital positions are filled by contract or on-call employees who do not work regular shift hours but instead, perform medical services as needed. Those personnel must be contacted to perform a scheduled service. Therefore, regardless of how the enterprise application server actually determines which therapist to schedule for a patient, the application enters the treatment in a time block in a therapist's schedule located in the therapist's enterprise page. The therapist then accesses the schedule via any web browser and picks up any assignments. Alternatively or in addition, the enterprise server may also alert the therapist by telephone with a “canned” voice message or by paging the therapist from telephone numbers stored for the therapist on the enterprise database. From the therapist's enterprise web page, the respiratory therapist, using a web browser, acknowledges the assignment which is immediately transmitted to the enterprise application as a response message transaction. The enterprise application then processes the response message by performing a number of related enterprise truncations, such as notifying the attending physician and the patient's nursing unit that the therapist confirmed the appointment. Once the therapy session has been completed, the therapist merely re-accesses the schedule on the enterprise web page and indicates that the treatment has been completed. The enterprise application responds again by notifying the attending physician and the patient's nursing unit and also by indicating on the therapist's duty roster that the therapist is free for another assignment.

While theoretically the enterprise application could send updated messages to ancillary systems responsible for respiratory therapy, billing and Medical Records, it is expected that the therapy trigger event information is received in the usual manner by the ancillary systems (i.e. manual entry at a terminal for one ancillary system and via HL7 messages to others). This is so since the enterprise system is layered on top of the ancillary systems and the AIG catcher does not provide bi-directional communication between the enterprise server and the ancillary systems. Therefore, it is possible that, under certain circumstances, the enterprise application might receive multiple messages concerning the identical event, one from an enterprise web client and another from an ancillary system. This situation is usually not harmful to the enterprise database because the enterprise application recognizes multiple message instances of the same event and only processes the enterprise transaction for the first message instance.

By diverging here to the prior art method of scheduling a patient for respiratory treatment, the advantages of the exemplary embodiment of the present invention described above becomes clearer. Normally, a floor nurse dispatches a respiratory therapist. However, before the nurse can alert the therapist, the nurse must be notified of the prescribed treatment. The nurse might schedule the treatment from comments left on the patient's bedside chart by the attending physician. Nonetheless, it is more likely that the physician's instructions will be sent first to the responsible department and entered into that department's ancillary system. Thus, the orders become a trigger event which generates one or more messages to other ancillary systems. At some point, from some system, a paper order is generated and delivered to the nurse's station for the patient. From this point, the process becomes extremely manual with a nurse checking schedules for a therapist and after finding one responsible for the patient's room, then the nurse looks up the therapist's telephone number and pager number. The nurse calls or pages the therapist, who is unavailable and later, when the therapist calls the nurse's station, the nurse who paged the therapist is unavailable and the treatment does not get scheduled. As may be apparent, the nurse and therapist may miss connections for several iterations until they finally connect and schedule the treatment.

With respect to FIG. 11, a flowchart depicting a lower level enterprise process in which the enterprise application processes a transaction request message, is illustrated in accordance with an exemplary embodiment of the present invention. The flowchart depicted in FIG. 11 is a lower level example of the flowchart depicted in FIGS. 9A-9C. In the present example, the enterprise message is actually a request for an enterprise service. Functional blocks shown in the flowchart depicted on FIG. 11 correspond to functional blocks depicted in FIGS. 9A to 9C with the least two digits remaining constant between corresponding functional blocks. Thus, performing the enterprise transaction begins with the enterprise application receiving an enterprise message shown as step 1102 in the present figure as opposed to 902 in FIG. 9A. As described above, the enterprise application then identifies the sender, the message type and the transaction type (step 1104). In this case, the message type is a request and the transaction type is an enterprise request for scheduling a service. The enterprise application then extracts the service request from the message (step 1140). That is to say, the enterprise application extracts the precise data elements that define the service request from the message. Once the message, transaction and service have been identified and data has been extracted from the message, the enterprise application retrieves the enterprise relationship and privilege rules for the service being requested (step 1142).

Next, the enterprise application retrieves any enterprise data from the enterprise database necessary to processing either the requested transaction or any related transactions (step 1146). Generally, with respect to an enterprise service request, it is expected that this information may include information describing the patient and service. For example, in response to a request message from an attending physician for a particular patient to be scheduled for respiratory therapy, certain facts about the patient must be available to the enterprise application prior to the application being able to execute the transaction. These facts may include whether the patient is an in-patient or out-patient and if the patient is an in-patient, the location of the patient, that is, the site or building, the floor on the site, the room, the bed, the nurse's station, etc. Also, the identity of the patient's attending physician and the group of physicians which he is granted privilege is identified. Alternatively, the patient may not have been admitted to the hospital, but instead, may be an out-patient. In that case, the most convenient care facility's location to the patient that supports the requested service must be identified for the patient's location and, again, information about the attending physician must also be retrieved (step 1146A1). With respect to the service to be performed, the enterprise application accesses the technician duty roster and notification information for service technicians which are available at the time period of the scheduled service and which service the patient's location (step 1146A2).

After retrieving the necessary enterprise data, the enterprise application can process any transactions that are related to the requested transaction. For example, a privilege check is performed by comparing the requestor's user ID to the user ID of the attending physician (step 1156A). If the requester is not the attending physician, the process reverts to the privilege routine depicted above with respect to FIG. 10. However, privilege checks are not necessarily in the exclusive domain of the enterprise system. Since the order for the respiratory care is entered into the order entry disparate system, all authentication and privilege checking for the appropriateness of the order is done in that ancillary system. If the order is not appropriate, it would not have passed the edits of the ancillary system and therefore, the enterprise system would not have received the transmitted message for the order. Once a privilege check is completed, the enterprise application performs other enterprise transactions that are related to the service request and an available technician is identified to perform the requested service (step 1156B). Once a technician has been identified, that technician is automatically notified of the patient's scheduling request by updating the technician's enterprise web page. Once the technician has been notified, the enterprise application, if applicable, notifies a patient's nurse's station of the service being scheduled (step 1156D). The patient's nursing unit is notified of the scheduled service by merely updating the patient information on the nursing unit's enterprise page. At this point, the enterprise application waits for a response from the technician. If the technician does not respond within a pre-set time limit or prior to a predetermined time period established prior to the scheduled service, the enterprise application may escalate to a secondary routine which notifies all concerned parties that the scheduled service has not been confirmed by the technician. At that point, the attending physician may attempt to reschedule the service or personally contact the technician or the nursing unit for verification that the service will actually be performed at the appointed time. However, under most circumstances, it is expected that the technician will respond to the schedule by merely checking off an acknowledgment on the technician's enterprise page which is then immediately transmitted to the enterprise application. At that point, the enterprise application notifies the nursing unit that the technician has confirmed the scheduled service (step 1156F). After the confirmation of the service, all of the related enterprise transactions have been completed and the patient's records can be updated with the requested service scheduling information. The scheduling of the requested service is, of course, the requested transaction by the requestor or attending physician (step 1158). Thus, once completed, the enterprise performance of the message transaction is completed.

Below is an exemplary data flow for respiratory care notification in accordance with the present invention. The data flow will be described with respect to enterprise network 500 depicted in FIG. 5. Recall that in practice, the functionality of AIG catcher 520 is contained within enterprise server 530 and the information on vendor specific mapping tables 522 is actually stored on enterprise database 532. The respiratory care notification process begins with an order record (i.e. ORM-O01 HL7 transaction) being received by AIG catcher 520. AIG catcher 520 places the received Order Record Detail into the “Orders” table in enterprise database 532. Upon insert into the Orders database table, enterprise server 530 applies enterprise relationship, privilege and access rules in the form of executing scripts. In accordance with one embodiment, applying enterprise relationship rules is a combination of SQL triggers and stored procedures. This trigger investigates order number to determine type. If order type is “Respiratory,” then:

Insert order data into Respiratory Tables

Execute Respiratory Paging scripts (stored procedure)

The respiratory paging stored procedure shown below is then invoked.

Accept order key information.

Query enterprise database for specific patient information such as room/bed and other census data.

Build telephonic pager message with detailed respiratory order and patient data

Query enterprise database for respiratory on-call pager assigned to the unit that corresponds to the patient's unit.

If no pager is assigned, determine pager number for respiratory supervisor

Execute stored procedure to send text message to alert assigned respiratory therapist that an order is pending

Once the telephonic pager message has been built, a telephonic page stored procedure is invoked as described below:

Accept telephonic pager message data.

Insert patient data, care message data and telephonic pager number data into PagerQueue table of enterprise database.

In accordance with one embodiment of the present invention, a telephonic pager service program is invoked, specifically an NT service API that's functionality is summarized below:

Periodically (timer controlled) checks PagerQueue table for “pending” telephonic page messages.

Pager data is read from PagerQueue table.

Look up telephonic pager service carrier protocols from enterprise database related to pager key identified in pager message.

Set dial-up and modem settings to match those for identified pager service carrier.

Transmit data to pager service via dial-up through attached modem device.

While the above described process is an elegant method for invoking a specific type of enterprise relationship rule (scheduling) that utilizes off the shelf Windows NT APIs for easy of development, a significant drawback has been uncovered pertaining to those APIs. The scheduler service cannot be fully implemented due to memory leaks within certain APIs of the scheduling module that do not surface as problematic until considerable volume paging requests within the system are reached. The “pager queue” memory fills up without leaving space to store new pager requests. One solution employed in practice is merely to monitor the pager memory and then “cycle” the ENTERPRISEPager service. That solution generally requires human intervention and thus, is somewhat less efficient. An alternative solution is to replace the suspect APIs with custom APIs written for the specific enterprise system. While this solution has obvious benefits, it is relatively more expensive and requires very high level communications code be written to interface directly to the device drivers for a COM port on the WIN32 operating system.

Specifically, one component not shown in the figures with respect to the enterprise server is an ENTERPRISEPager service. This is an NT service that runs on the enterprise application server. One of the functions of the ENTERPRISEPager is to monitor the table of “pager queue” that contains “pending pages”. It simply accesses the table via standard ODBC database connection, performs its processing, and then goes to sleep for a pre-determined interval. If the service wakes up, reads the queue and finds pending pages data, it then utilizes the Microsoft Telephony Application Programming Interface (TAPI) to initiate a connection to a predefined serial port (COM/communications port) on the enterprise server where a waiting modem hardware device is located (not shown in the figures). The hardware modem device is utilized to contact the telephonic paging service directly via direct telephonic communication protocols. TAPI is a set of DLLs that allows a programmer to make programming calls to specialized drivers for each of the telephony functions such as open phone line, dial number, send message, get response, hang up, etc. It alleviates the need for the programmer to write very high level communications code that interface directly to the device drivers for the COM port on the WIN32 operating system. The memory problem is that when these APIs are utilized in a high-volume environment, such as our hospital respiratory scheduling solution, each call to the TAPI APIs leaks a small amount of memory that doesn't get cleaned up properly. Therefore, more pages are requested, the ENTERPRISEPager service exceeds its memory allocation limits and “hangs up” the service causing it to fail. In accordance with a currently practiced embodiment, the pager queue table on the database is constantly monitored. If outstanding messages are discovered that, based on predetermined criteria, are old and should have previously been sent, a message is sent to an on-call analyst and the ENTERPRISEPager service is manually cycled. This effectively “clears” the memory allocated to the service and allows it to operate as before, until it reaches its “hang” limit again but requires human intervention in order to ensure that the all pending pages are sent.

The second solution is to remove the calls to the TAPI DLLs and write custom telephony communication logic (and or DLLs) for the enterprise application that, at a high level, interface directly to the device drivers for the COM port on the WIN32 operating system, thereby automatically granting effective communication with the attached hardware modem for successful and error free.

Messaging within the enterprise system is not strictly limited to messages between the enterprise server and the AIG catcher or enterprise clients, but under certain conditions, the enterprise server can receive system level messages directly from any one of the ancillary systems. Normally, direct communication between the enterprise server and any of the ancillary systems is limited to block data transfers. Block transfers of data are especially useful when an enterprise data error is discovered in the enterprise database due to an invalid HL7-to-enterprise data-mapping table being employed by the AIG catcher. The function of the AIG catcher is to convert HL7 compliant messages to enterprise messages using a set of vendor-specific HL7-to-enterprise data-mapping tables. As each update to a definition in any of the HL7, auxiliary and proprietary specifications is modified, the corresponding HL7-to-enterprise data-mapping table must also be amended in order to properly convert message data for HL7 format to a format used by the enterprise. To obtain this level of confidence for entering data, the AIG catcher must be expeditiously updated with revisions and upgrades from each vendor of the disparate, ancillary systems.

Problems occur when and if the AIG catcher is not fitted with the most current version of a vendor-specific HL7-to-enterprise data-mapping table. In those cases, invalid or erroneous enterprise information may be entered into the enterprise database in response to valid event triggered data. Even more destructive, valid enterprise data may be overwritten with invalid enterprise information and that information is then used to for the performance of related enterprise transactions. There may be cases when enterprise data corrupts other related enterprise data due to enterprise relationship rules that update related enterprise data. Thus, the only remedy to data errors in the enterprise database is to drill down into the enterprise database to the first layer of valid information, which may be far below the layer where the error was introduced, and reprocess all subsequent event triggered information into the enterprise database.

Aside from the reprocessing task, the obvious problem here is that there is no ready source of system level event triggered information from the affected ancillary system or systems. The AIG does not maintain a persistent storage for all HL7 messages received and delivered, and similarly, the AIG catcher merely receives and processes the message from the AIG. The AIG catcher uses the enterprise database for its storage therefore, if the enterprise database is corrupted, the AIG catcher would be of little help. Even if the AIG catcher did have the ability to store information contained in the messages from the AIG, that data too may be suspect because it is the functionality of the AIG catcher that is faulty. Recall also that there may be cases where faulty event triggered information from a specific ancillary system may affect other related data stored in the enterprise system. For example, in cases where the faulty data is retrieved from the enterprise database for processing data received from a second ancillary system, the processed data from the second ancillary system may also contain errors due to the faulty enterprise data. Thus, one solution is to recover event triggered information not only from the ancillary system's databases, which is the source of the faulty enterprise data, but also from any other disparate, ancillary databases whose corresponding enterprise data was corrupted because of the fault. Both ancillary systems' data can be reprocessed using the appropriate relationship rules and then stored in the enterprise database.

The following information pertains to the building of a request that is then sent to the ancillary system requesting block transfer of data that is, in turn, reprocessed. As stated earlier, not every embodiment takes advantage of the block copy feature of HL7 so the depicted process would not be appropriate in those cases. Event data will, most probably, have to be drilled out of multiple disparate, ancillary systems' databases. As a practical matter, even when the needed data is identified in the ancillary system's databases, it cannot be restored into the enterprise database using the AIG catcher route because the restoration data itself would collide with temporal event triggered messages. The most reliable solution is for the enterprise server to communicate directly with the disparate, ancillary systems. The enterprise server may communicate to an ancillary application using either the HL7 messaging standard or vendor-specific messaging standard used by the ancillary system. Using either messaging protocol, the enterprise application utilizes vendor-specific database access rules that function somewhat inversely from the vendor-specific HL7-to-enterprise data-mapping tables used by the AIG catcher for structuring a data request message, such as an HL7 Master Files Query (MFQ). 1) Identify each enterprise data element value needed to be restored in the enterprise database, 2) convert the identified enterprise data elements to vendor-specific, HL7 messaging values, and 3) generate an HL7 compliant request message using the vendor-specific data element identities.

A second set of rules is used by the enterprise application for deciphering the query response message from an ancillary system, such as a Master Files Response (MFR). These rules function identically to the data conversion portion of the vendor-specific HL7-to-enterprise data-mapping tables used by the AIG catcher but, rather than generating an enterprise message, the enterprise data is used to populate the enterprise database.

Data transfer difficulties may be manifest when the enterprise application is accessing system level event triggered data from one or more of the ancillary systems and the AIG catcher is passing temporal, even triggered enterprise data, to the enterprise application. Therefore, rather than block transferring data directly to the enterprise application for storage in the enterprise database, the information may be temporarily housed in a repair database. The repair database allows system administrators to analyze the enterprise data collected from the ancillary systems for errors and completeness prior to populating the enterprise database. The system level event information from the ancillary system's databases are accessed and that information is processed using corrected HL7-to-enterprise data-mapping tables as described above. Then, once the information in the repair enterprise database is current, the entire contents of the repair database is transferred to the enterprise database between messages from the AIG catcher. Thus, with the exception of any temporal event triggered messages being processed by the AIG catcher, and those are held until the enterprise database is updated with restoration data from the repair database, the information in the repair database is current.

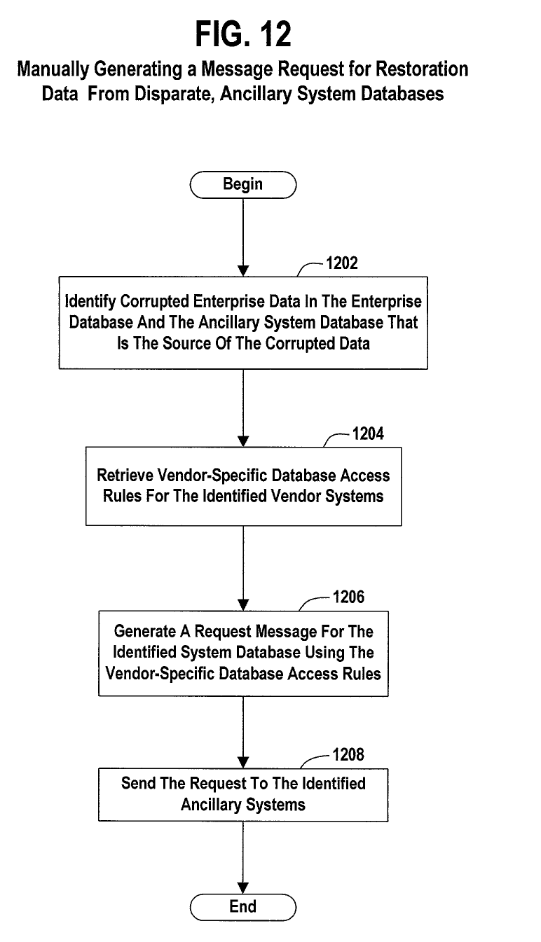

It should be noted that restoring enterprise data in the enterprise database can be a manual process, using manually generated messages or more automated, by using data retrieval scripts that automate portions of the process. With reference to FIG. 12, a flowchart depicting process for manually generating a message request for restoration data from a disparate, ancillary system is illustrated in accordance with an exemplary embodiment of the present invention. The process begins by identifying both the corrupted enterprise data in the enterprise database and the ancillary system database that is the source for the system level event data that corresponds to the corrupted data (step 1002). Vendor-specific database access rules are then retrieved from the enterprise database for accessing the identified vendor supported ancillary systems (step 1204). Using the rule, a request message is generated for the identified ancillary system database (step 1206). Remember, the message might either be an HL7 compliant message or some vendor-specific compliant protocol message, but in any case, the request identifies corresponding system level event data for the enterprise data to be updated. After the message is generated, it is sent directly to the identified ancillary system (step 1208) and the process ends. In response, the ancillary system application returns a data message containing the requested system level information. That message transaction is processed in accordance with the message transaction processing method described above with respect to FIGS. 9A and 9C.

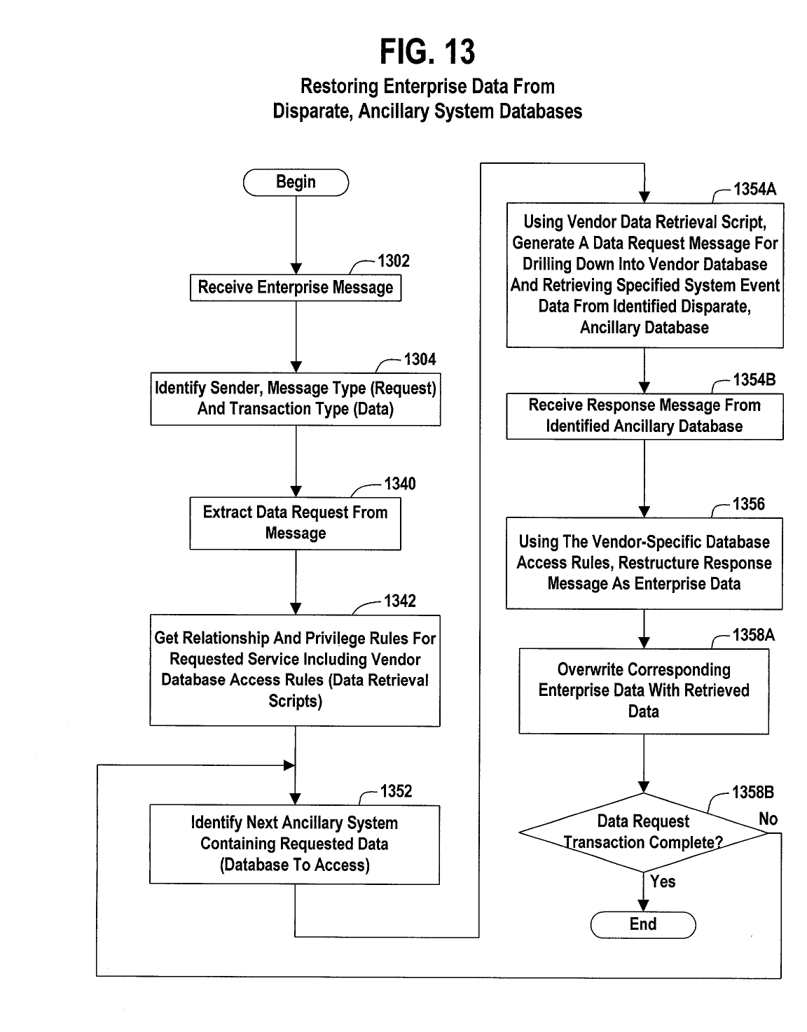

Enterprise data restoration on the enterprise database may require more than one ancillary system's database to be accessed and system level event data retrieved from those systems. Therefore, a more automated process for generating data request messages is sometimes useful. FIG. 13 is a flowchart depicting an automated process for restoring enterprise data to the enterprise database using system level event data from one or more of the disparate, ancillary systems' databases in accordance with a preferred embodiment of the present invention. The flowchart depicted in FIG. 13 is a lower level process of that depicted in FIGS. 9A and 9C above and the functional blocks shown in FIG. 13 correspond to functional blocks depicted in FIGS. 9A and 9C, with the least two digits remaining constant between corresponding functional blocks. The process begins by the enterprise application receiving an enterprise message from an enterprise web client for the restoration of data in the enterprise database (step 1302). The enterprise application identifies the sender, the message type and the transaction type and authorizes the user (step 1304). In this case, the message type is a request and the transaction type is a restoration request that will require the enterprise system to retrieve system level event data from an ancillary system database. The enterprise application then extracts the particular enterprise data element defining the data request from the message (step 1340).

Using the particular data elements in the message and transaction types, the enterprise application then gets the relationship and privilege rules for the requested transaction (step 1342). The enterprise application also retrieves vendor-specific database access rules from the enterprise database. Here, the enterprise application performs a variety of related enterprise transactions including recursively identifying ancillary systems to be queried and generating data queries for those systems. The system level data in the responses from the identified systems will be processed into enterprise data before the enterprise system can perform the requested transaction of restoring enterprise data into the enterprise database. In practice, the rules might be used by the enterprise application retrieving system level data or might instead be implemented as data retrieval scripts that execute automatically for retrieving data from the ancillary system databases. These scripts contain the functionality necessary to drill down into a vendor database for system level data that corresponds to the requested enterprise data. Thus, the enterprise system administrator is relieved of the burden for understanding each disparate, ancillary system to that level necessary for retrieving specific data types. Regardless, with these rules, an ancillary system is identified that contains at least a portion of the system level data that corresponds to the requested enterprise data (step 1352). Next, a data request message is generated using the vendor-specific rule or scripts that identify the system level event data needed to restore the corrupted enterprise data in the enterprise database (step 1354A). Using vendor-specific data accesses rules, specific system level event information is drilled out of a system database and the ancillary system returns a response message to the enterprise system with the data (step 1354B). By using the vendor-specific database access rules for converting the system level event data in the system message to enterprise data (step 1356) and as described several times above, the enterprise application then processes the message transaction.

Finally, the enterprise application performs the requested restoration transaction and writes the enterprise data to the appropriate data fields in the enterprise database (the enterprise application may also create data field for the entries) (step 1358A). As mentioned above, completely restoring corrupted enterprise data in the enterprise database might require that several ancillary system databases to be queried for system level event data. Therefore, prior to exiting the restoration process, the enterprise application determines whether another system should be queried for data (step 1358B). If additional system level data is necessary to complete the restoration of the enterprise database, the process reverts to step 1352 where the next ancillary system is identified that contains system level data that corresponds to the requested enterprise data. The process continues to iterate through the various ancillary systems until all of the requested enterprise data is recovered from the ancillary systems (step 1358B). At that point, the process ends.

In addition to those mentioned above, the enterprise application supports other functionality that may or may not utilize enterprise relationship rules that are automatically applied to the contents of both received HL7 messages and received enterprise messages. One such enterprise function involves an automated electronic faxing feature for transmitting electronic copies of a document in fax format (files with an .awd extension). Initially, a care provider, such as a physician, dictates a report into a Medical Records Dictation System (a disparate, ancillary systems in the enterprise). An exemplary report can be a History and Physical, Operative Report, Discharge Summary, Consultation, etc. or any other narrative that the care provider wishes to include in the patient's clinical medical record. The Medical Records Department transcribes the report that has been dictated. These transcribed “Results”, as they are known in the art, are received from the AIG through the AIG catcher and placed directly into the enterprise database as a matter of general course for the enterprise system as previously described.

There are two primary usages of the electronic faxing feature of the enterprise system: automated faxing to a dedicated remote location, such as a physician's office; and demand faxing by a medical records staff employee. With respect to automated faxing to a dedicated remote location, such as a physician's office, every care provider with enterprise access privileges can request that a “copy” (facsimile) of a signed document be electronically transmitted to their office via fax transmission. This “rule” is actually saved in an ancillary system's core database. Whenever a new document (report) is received through the HL7 interface by the enterprise system, it contacts the ancillary system's core database directly looking up each physician noted on the report as dictating physician, as well as all physicians noted in the “cc:” list at the bottom of the report to determine if each of these physicians is eligible to receive a transmitted facsimile copy of the report. In addition to the eligibility switch for each participating physician, there are some enterprise rules that are applied which additionally govern the eligibility of certain key documents. For example, if the principle patient identified in the report has been admitted to the hospital for one of several privileged classes such as Behavioral Health, Chemical Dependency, HIV, etc., the report in question will fail the eligibility rules and therefore become ineligible for faxing and consequently not get faxed out of the control of the enterprise. For each care provider and report that is eligible for the transmitted facsimile, the enterprise server will make a call to another enterprise fax component module (program) passing all relevant information pertaining to the recipient care provider, care provider fax number, as well as a pointer to the report data that is to be transmitted. The enterprise fax component will then create an electronic copy of the report in memory and then pass this electronic report on to an enterprise fax server.

Demand faxing by a medical records staff employee is somewhat different than automated faxing to a dedicated remote location in that the faxing function is initiated by the sender rather than the intended recipient. Initially, a Medical Records Department employee must have special privileges in the enterprise application that allows for a transcribed report to be “looked up” and then sent via facsimile through the enterprise fax server. Here, no enterprise rules are applied other than the privilege check for the medical records employee. Once the report has been identified, the enterprise user can then fax the report directly to:

Any physician that is currently “of record” for the identified patient visit to the hospital (i.e. any admitting, attending, referring, consulting physician, etc. for this patient's stay in the hospital);

Any physician's office fax number (looked up by the enterprise server via direct connection to the ancillary system containing all physician data); or

Any valid fax number that the enterprise may not have encountered before.

It is assumed that the medical records staff personnel have been properly trained and therefore “know” who can receive what according to the policies and practices of the institution. For this reason, the enterprise rules of eligibility for privileged patient classes such as Behavioral Health/Chemical Dependency, etc. are not enforced.

Still another enterprise function that may or may not utilize enterprise relationship rules that are automatically applied to the contents of both received HL7 messages and received enterprise messages is an electronic signature (eSign) feature. Initially, a care provider dictates a report into a Medical Records Dictation System as described immediately above which is transcribed by the Medical Records department of the enterprise. The transcribed results are received from the AIG through the AIG catcher and placed directly into the enterprise database as is a matter of general practice as previously described.

Every care provider with enterprise access privileges can request the “authority” to be allowed to eSign documents with the framework of the enterprise system. Physician eSign eligibility is set by and with the authorization of the administrators of the Medical Records Department. If a care provider is “eligible” for the eSign feature, the care provider can navigate to the eSign screens from their personal enterprise web page. Once in, the enterprise system determines when the physician's eSign eligibility started (effective date/time) and then queries the results tables for any active results that were dictated by this physician that have not yet been eSigned. These are presented to the care provider for review and processing. Results documents are presented for review by the care provider by results category. For example, a care provider prompted by the enterprise web server to examine one of the following results groups: all unsigned results for the present document; is doc; all unsigned results for a given patient; or a single specific unsigned result only. When results prompt is answered, the unsigned result is presented to the care provider in an editable window. Once displayed, the care provider can review the result and process the result in one of three ways, either: accept the result as is without changes and mark the result for eSign; reject the result as is and not mark the result for eSign; or finally, edit to correct the result by adding, changing and/or omitting portions of the results and then mark the edited results for eSign.

Once all processing is done, the care provider can click the “Sign” button that will enable them to verify their electronic signature via providing their User ID and password, again. If the care provider signs a record, it is flagged as “carved into stone” on the enterprise database and protected from future updates. It is impossible for a care provider to make changes to a document once it has been signed. Edits must be accomplished by dictating an “addendum”, and have that document transcribed, added to the enterprise database and ultimately, only then eSign the addendum. Similarly, any rejections to a result made by a care provider require the care provider to state a reason for the rejections such as poor transcription, too many errors, etc. Then, this information is sent to the Medical Records transcription department via an electronic “in-basket” of physician rejects. These are then monitored via GUI screen, re-worked and then re-submitted to the physician via the standard HL7 interface. When the newer version of the transcribed report is received, the older, rejected version of the transcription is overwritten with the new report. The older reject is still noted in a “reject” log.

In the case that the physician is a “Resident” (physician in training), the resident will see his/her list of pending signature documents. They are allowed to eSign the documents (reports) exactly as described above. One caveat to this is that the record, once eSigned by a resident is not, in fact, “carved into stone” and unable to be edited/modified. It is only “flagged” as being eSigned by a resident. Each resident is assigned a “supervising” physician. This supervising physician is the ultimate eSign authority, over and above the resident, and must also eSign the resident's reports from his/her own in-basket before the report can be classified as “eSigned” completely and “carved into stone.” A second caveat to the eSign resident feature is as follows: a resident may dictate a report. When the report comes across HL7 interface to the enterprise database, it immediately becomes available for eSign by both the supervising physician and the resident. If, by chance, the supervising physician happens to eSign the report before the resident checks their eSign in-basket, the resident will not be given the opportunity to eSign their own dictation. The reason for this is that the report becomes “carved into stone” once the supervising physician completes the eSign of the report.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application and to enable others of ordinary skill in the art to understand the invention for various embodiments with various modifications as are suited to the particular use contemplated.

What is claimed is:

1. A data processing system implemented method for accomplishing an enterprise event based on a unified collection of information realized from a plurality of disparate, ancillary systems comprising:
catching a message, wherein the message was generated by a disparate, ancillary system using a set of content rules and the message conforms to a message standard;
opening the message;
identifying the disparate, ancillary system based on the message;
accessing content conversion rules based on the identity of the disparate, ancillary system;
converting content from the message to enterprise information using the content conversion rules;
retrieving enterprise relationship rules based on the enterprise information;
checking the enterprise information for a relationship with enterprise data based on the relationship rules; and
scheduling an enterprise event based on a relationship between the enterprise information converted from the message and the-enterprise data stored on the enterprise database.

2. The method recited above in claim 1 further comprising:
storing the enterprise information in the enterprise database.

3. The method recited above in claim 1, wherein the enterprise is a health care facility.

4. The method recited above in claim 1 further comprising:
receiving an enterprise request for access to data in the enterprise database;
identifying the portion of enterprise data from information from the enterprise request;
identifying the requestor from the enterprise request;
retrieving enterprise relationship rules based on the identity of the requester;
identifying at least one user with a privilege to the identified portion of enterprise data; and
granting the requester access to the identified portion of enterprise data based on the requester being identified as a user with the privilege to the identified portion of enterprise data.

5. The method recited above in claim 4, prior to granting the requester access to the identified portion of enterprise data the method further comprising:
comparing the identity of at least one user with a privilege to the identified portion with the identity of the requestor; and
returning a warning response to the requestor based on the outcome of the comparison.

6. The method recited above in claim 2 further comprising:
detecting an error in a portion of enterprise data maintained on the enterprise database;
identifying a source disparate, ancillary system, wherein the source disparate, ancillary system is a source for the portion of enterprise data;
locating the portion of enterprise data in the source disparate, ancillary system; and
accessing the source disparate, ancillary system for the portion of enterprise data.

7. The method recited above in claim 6 further comprising:
overwriting the portion of enterprise data maintained on the enterprise database with the portion of enterprise data from the source disparate, ancillary system.

8. The method recited above in claim 1, wherein the enterprise event is an enterprise service, scheduling the enterprise event further comprises:
identifying a recipient for the enterprise service from the enterprise information.

9. The method recited above in claim 8, wherein scheduling the enterprise event further comprises:
identifying an enterprise department responsible for administering the performance of enterprise services to the recipient based on the identity of the recipient for the enterprise service and the enterprise data.

10. The method recited above in claim 8, wherein scheduling the enterprise event further comprises:
identifying an enterprise service person responsible for performance the enterprise service based on the identity of the recipient the enterprise service and the enterprise data.

11. The method recited above in claim 8, wherein scheduling the enterprise event further comprises:
identifying an enterprise service person responsible for performance the enterprise service and an enterprise department responsible for administering the performance of enterprise services to the recipient based on the identity of the recipient the enterprise service and the enterprise data.

12. The method recited above in claim 9, wherein scheduling the enterprise event further comprises:
establishing a scheduling time for performance of the enterprise service; and
notifying the enterprise department responsible for administering the performance of enterprise services to the recipient of the scheduling time.

13. The method recited above in claim 10, wherein scheduling the enterprise event further comprises:
establishing a scheduling time for performance of the enterprise service; and
notifying the service person responsible for performance the enterprise service of the scheduling time.

14. The method recited above in claim 11, wherein scheduling the enterprise event further comprises:
establishing a scheduling time for performance of the enterprise service; and
notifying the enterprise service person responsible for performance the enterprise service and the enterprise department responsible for administering the performance of enterprise services to the recipient of the scheduling time.

15. The method recited above in claim 14, wherein notifying further comprises:
updating an enterprise web page with the scheduling time for performance of the enterprise service.

16. The method recited above in claim 15, wherein notifying further comprises:
accessing notification information for enterprise service person from the enterprise data;
selecting a transmission medium based on notification criteria in the notification information; and
trnasmitting a message using the transmission medium based on the notification information.

17. The method recited above in claim 16, wherein the transmission medium is a telephone, the notification information includes a telephone number, and the message is an oral notification.

18. The method recited above in claim 16, wherein the transmission medium is a pager, the notification information includes a pager telephone number, and the message is a text notification.

19. The method recited above in claim 15, wherein scheduling the enterprise event further comprises:
receiving an acknowledgment from the enterprise service person that the scheduling time for performance of the enterprise service has been received by the enterprise service person.

20. The method recited above in claim 19, wherein scheduling the enterprise event further comprises:
notifying the enterprise department responsible for administering the performance of enterprise services to the recipient that the enterprise service person responsible for administering acknowledges the scheduling time for performance of the enterprise service.

21. The method recited above in claim 1, wherein the enterprise event is an enterprise function, scheduling the enterprise event further comprises:
identifying an enterprise user responsible for executing the enterprise function from the enterprise information.

22. The method recited above in claim 21, wherein scheduling the enterprise event further comprises:
retrieving enterprise relationship rules based on the identity of the enterprise user;
identifying at least one user with a privilege to the enterprise function; and
granting the enterprise user access to the enterprise function based on the enterprise user being identified as a user with the privilege to the enterprise function.

23. The method recited above in claim 22 wherein scheduling the enterprise event further comprises:
updating an enterprise web page with at least a portion of the enterprise information a tool to perform the enterprise function.

24. The method recited above in claim 23 wherein the at least a portion of the enterprise information is a document and the tool to perform the enterprise function is an electronic signature tool.

25. The method recited above in claim 24 wherein the tool to perform the enterprise function further includes a document editing feature.

26. The method recited above in claim 25 wherein the editing feature of the tool to perform the enterprise function requires a separate privilege.

27. The method recited above in claim 22 wherein the enterprise user is one of a physician, an intern and a resident and the enterprise is a health care facility.

28. The method recited above in claim 24 wherein scheduling the enterprise event further comprises:
receiving an acknowledgment from the enterprise user that document has been electronically signed by the enterprise user.

29. The method recited above in claim 25 wherein scheduling the enterprise event further comprises:
receiving an acknowledgment from the enterprise user that document has been electronically edited and electronically signed by the enterprise user.

30. The method recited above in claim 24 wherein scheduling the enterprise event further comprises:
faxing a copy of the signed document to a destination based on the enterprise data.

31. A data processing system for accomplishing an enterprise event based on a unified collection of information realized from a plurality of disparate, ancillary systems comprising:
means for catching a message, wherein the message was generated by a disparate, ancillary system using a set of content rules and the message conforms to a message standard;
means for opening the message;
means for identifying the disparate, ancillary system based on the message;
accessing content conversion rules based on the identity of the disparate, ancillary system;
means for converting content from the message to enterprise information using the content conversion rules;
means for retrieving enterprise relationship rules based on the enterprise information;
means for checking the enterprise information for a relationship with enterprise data based on the relationship rules; and
means for scheduling an enterprise event based on a relationship between the enterprise information converted from the message and the enterprise data stored on the enterprise database.

32. The system recited above in claim 31 further comprising:
means for storing the enterprise information in the enterprise database.

33. The system recited above in claim 31, wherein the enterprise is a health care facility.

34. The system recited above in claim 31 further comprising:
means for receiving an enterprise request for access to data in the enterprise database;
means for identifying the portion of enterprise data from information from the enterprise request;
means for identifying the requestor from the enterprise request;
means for retrieving enterprise relationship rules based on the identity of the requester;
means for identifying at least one user with a privilege to the identified portion of enterprise data; and
means for granting the requestor access to the identified portion of enterprise data based on the requester being identified as a user with the privilege to the identified portion of enterprise data.

35. The system recited above in claim 34 further comprising:
means for comparing the identity of at least one user with a privilege to the identified portion with the identity of the requestor; and
means for returning a warning response to the requestor based on the outcome of the comparison.

36. The system recited above in claim 32 further comprising:
means for detecting an error in a portion of enterprise data maintained on the enterprise database;
means for identifying a source disparate, ancillary system, wherein the source disparate, ancillary system is a source for the portion of enterprise data;
means for locating the portion of enterprise data in the source disparate, ancillary system; and
means for accessing the source disparate, ancillary system for the portion of enterprise data.

37. The system recited above in claim 36 further comprising:
means for overwriting the portion of enterprise data maintained on the enterprise database with the portion of enterprise data from the source disparate, ancillary system.

38. The system recited above in claim 31, wherein the enterprise event is an enterprise service, the means for scheduling the enterprise event further comprises:
means for identifying a recipient for the enterprise service from the enterprise information.

39. The system recited above in claim 38, wherein the means for scheduling the enterprise event further comprises:
means for identifying an enterprise department responsible for administering the performance of enterprise services to the recipient based on the identity of the recipient for the enterprise service and the enterprise data.

40. The system recited above in claim 38, wherein the means for scheduling the enterprise event further comprises:
means for identifying an enterprise service person responsible for performance the enterprise service based on the identity of the recipient the enterprise service and the enterprise data.

41. The system recited above in claim 38, wherein the means for scheduling the enterprise event further comprises:
means for identifying an enterprise service person responsible for performance the enterprise service based on the identity of the recipient the enterprise service and the enterprise data; and
means for identifying an enterprise department responsible for administering the performance of enterprise services to the recipient based on the identity of the recipient the enterprise service and the enterprise data.

42. The system recited above in claim 39, wherein the means for scheduling the enterprise event further comprises:
means for establishing a scheduling time for performance of the enterprise service; and
means for notifying the enterprise department responsible for administering the performance of enterprise services to the recipient of the scheduling time.

43. The system recited above in claim 40, wherein the means for scheduling the enterprise event further comprises:
means for establishing a scheduling time for performance of the enterprise service; and
means for notifying the service person responsible for performance the enterprise service of the scheduling time.

44. The system recited above in claim 41, wherein the means for scheduling the enterprise event further comprises:
means for establishing a scheduling time for performance of the enterprise service; and
means for notifying the enterprise service person responsible for performance the enterprise service and the enterprise department responsible for administering the performance of enterprise services to the recipient of the scheduling time.

45. The system recited above in claim 44, wherein the means for notifying further comprises:
means for updating an enterprise web page with the scheduling time for performance of the enterprise service.

46. The system recited above in claim 45, wherein the means for notifying further comprises:
means for accessing notification information for enterprise service person from the enterprise data;
means for selecting a transmission medium based on notification criteria in the notification information; and
means for trnasmitting a message using the transmission medium based on the notification information.

47. The system recited above in claim 46, wherein the transmission medium is a telephone, the notification information includes a telephone number, and the message is an oral notification.

48. The system recited above in claim 46, wherein the transmission medium is a pager, the notification information includes a pager telephone number, and the message is a text notification.

49. The system recited above in claim 45, wherein the means for scheduling the enterprise event further comprises:
means for receiving an acknowledgment from the enterprise service person that the scheduling time for performance of the enterprise service has been received by the enterprise service person.

50. The system recited above in claim 49, wherein the means for scheduling the enterprise event further comprises:
means for notifying the enterprise department responsible for administering the performance of enterprise services to the recipient that the enterprise service person responsible for administering acknowledges the scheduling time for performance of the enterprise service.

51. The system recited above in claim 31, wherein the enterprise event is an enterprise function, the means for scheduling the enterprise event further comprises:
means for identifying an enterprise user responsible for executing the enterprise function from the enterprise information.

52. The system recited above in claim 41, wherein the means for scheduling the enterprise event further comprises:
means for retrieving enterprise relationship rules based on the identity of the enterprise user;
means for identifying at least one user with a privilege to the enterprise function; and
means for granting the enterprise user access to the enterprise function based on the enterprise user being identified as a user with the privilege to the enterprise function.

53. The system recited above in claim 52 wherein the means for scheduling the enterprise event further comprises:
means for updating an enterprise web page with at least a portion of the enterprise information a tool to perform the enterprise function.

54. The system recited above in claim 53 wherein the at least a portion of the enterprise information is a document and the tool to perform the enterprise function is an electronic signature tool.

55. The system recited above in claim 54 wherein the tool to perform the enterprise function further includes a document editing feature.

56. The system recited above in claim 55 wherein the editing feature of the tool to perform the enterprise function requires a separate privilege.

57. The system recited above in claim 52 wherein the enterprise user is one of a physician, an intern and a resident and the enterprise is a health care facility.

58. The system recited above in claim 54 wherein the means for scheduling the enterprise event further comprises:
means for receiving an acknowledgment from the enterprise user that document has been electronically signed by the enterprise user.

59. The system recited above in claim 55 wherein the means for scheduling the enterprise event further comprises:
means for receiving an acknowledgment from the enterprise user that document has been electronically edited and electronically signed by the enterprise user.

60. The system recited above in claim 54 wherein the means for scheduling the enterprise event further comprises:
means for faxing a copy of the signed document to a destination based on the enterprise data.

61. A computer readable storage medium storing program instructions for execution on a data processing system which when executed cause the data processing system to perform a method for accomplishing an enterprise event based on a unified collection of information realized from a plurality of disparate, ancillary systems, the method comprising:
catching a message, wherein the message was generated by a disparate, ancillary system using a set of content rules and the message conforms to a message standard;
opening the message;
identifying the disparate, ancillary system based on the message;
accessing content conversion rules based on the identity of the disparate, ancillary system;
converting content from the message to enterprise information using the content conversion rules;
retrieving enterprise relationship rules based on the enterprise information;
checking the enterprise information for a relationship with enterprise data based on the relationship rules; and
scheduling an enterprise event based on a relationship between the enterprise information converted from the message and the enterprise data stored on the enterprise database.

62. The system recited above in claim 61 further comprising:
storing the enterprise information in the enterprise database.

63. The system recited above in claim 61, wherein the enterprise is a health care facility.

64. The system recited above in claim 61 further comprising:
receiving an enterprise request for access to data in the enterprise database;
identifying the portion of enterprise data from information from the enterprise request;
identifying the requester from the enterprise request;
retrieving enterprise relationship rules based on the identity of the requester;
identifying at least one user with a privilege to the identified portion of enterprise data; and
granting the requester access to the identified portion of enterprise data based on the requester being identified as a user with the privilege to the identified portion of enterprise data.

65. The system recited above in claim 64 further comprising:
comparing the identity of at least one user with a privilege to the identified portion with the identity of the requester; and
returning a warning response to the requester based on the outcome of the comparison.

66. The system recited above in claim 62 further comprising:
detecting an error in a portion of enterprise data maintained on the enterprise database;
identifying a source disparate, ancillary system, wherein the source disparate, ancillary system is a source for the portion of enterprise data;
locating the portion of enterprise data in the source disparate, ancillary system; and
accessing the source disparate, ancillary system for the portion of enterprise data.

67. The system recited above in claim 66 further comprising:
overwriting the portion of enterprise data maintained on the enterprise database with the portion of enterprise data from the source disparate, ancillary system.

68. The system recited above in claim 61, wherein the enterprise event is an enterprise service, scheduling the enterprise event further comprises:
identifying a recipient for the enterprise service from the enterprise information.

69. The system recited above in claim 68, wherein scheduling the enterprise event further comprises:
identifying an enterprise department responsible for administering the performance of enterprise services to the recipient based on the identity of the recipient for the enterprise service and the enterprise data.

70. The system recited above in claim 68, wherein scheduling the enterprise event further comprises:
identifying an enterprise service person responsible for performance the enterprise service based on the identity of the recipient the enterprise service and the enterprise data.

71. The system recited above in claim 68, wherein for scheduling the enterprise event further comprises:
identifying an enterprise service person responsible for performance the enterprise service based on the identity of the recipient the enterprise service and the enterprise data; and
identifying an enterprise department responsible for administering the performance of enterprise services to the recipient based on the identity of the recipient the enterprise service and the enterprise data.

72. The system recited above in claim 69, wherein scheduling the enterprise event further comprises:
establishing a scheduling time for performance of the enterprise service; and
notifying the enterprise department responsible for administering the performance of enterprise services to the recipient of the scheduling time.

73. The system recited above in claim 70, wherein scheduling the enterprise event further comprises:
establishing a scheduling time for performance of the enterprise service; and
notifying the service person responsible for performance the enterprise service of the scheduling time.

74. The system recited above in claim 71, wherein scheduling the enterprise event further comprises:
establishing a scheduling time for performance of the enterprise service; and
notifying the enterprise service person responsible for performance the enterprise service and the enterprise department responsible for administering the performance of enterprise services to the recipient of the scheduling time.

75. The system recited above in claim 74, wherein notifying further comprises:
updating an enterprise web page with the scheduling time for performance of the enterprise service.

76. The system recited above in claim 75, wherein notifying further comprises:
accessing notification information for enterprise service person from the enterprise data;
selecting a transmission medium based on notification criteria in the notification information; and
transmitting a message using the transmission medium based on the notification information.

77. The system recited above in claim 76, wherein the transmission medium is a telephone, the notification information includes a telephone number, and the message is an oral notification.

78. The system recited above in claim 76, wherein the transmission medium is a pager, the notification information includes a pager telephone number, and the message is a text notification.

79. The system recited above in claim 75, wherein scheduling the enterprise event further comprises:
receiving an acknowledgment from the enterprise service person that the scheduling time for performance of the enterprise service has been received by the enterprise service person.

80. The system recited above in claim 79, wherein scheduling the enterprise event further comprises:
notifying the enterprise department responsible for administering the performance of enterprise services to the recipient that the enterprise service person responsible for administering acknowledges the scheduling time for performance of the enterprise service.

81. The system recited above in claim 61, wherein the enterprise event is an enterprise function, scheduling the enterprise event further comprises:
identifying an enterprise user responsible for executing the enterprise function from the enterprise information.

82. The system recited above in claim 81, wherein scheduling the enterprise event further comprises:
retrieving enterprise relationship rules based on the identity of the enterprise user;
identifying at least one user with a privilege to the enterprise function; and
granting the enterprise user access to the enterprise function based on the enterprise user being identified as a user with the privilege to the enterprise function.

83. The system recited above in claim 82 wherein scheduling the enterprise event further comprises:
updating an enterprise web page with at least a portion of the enterprise information a tool to perform the enterprise function.

84. The system recited above in claim 83 wherein the at least a portion of the enterprise information is a document and the tool to perform the enterprise function is an electronic signature tool.

85. The system recited above in claim 84 wherein the tool to perform the enterprise function further includes a document editing feature.

86. The system recited above in claim 85 wherein the editing feature of the tool to perform the enterprise function requires a separate privilege.

87. The system recited above in claim 82 wherein the enterprise user is one of a physician, an intern and a resident and the enterprise is a health care facility.

88. The system recited above in claim 84 wherein scheduling the enterprise event further comprises:
receiving an acknowledgment from the enterprise user that document has been electronically signed by the enterprise user.

89. The system recited above in claim 85 wherein scheduling the enterprise event further comprises:
receiving an acknowledgment from the enterprise user that document has been electronically edited and electronically signed by the enterprise user.

90. The system recited above in claim 84 wherein scheduling the enterprise event further comprises:
faxing a copy of the signed document to a destination based on the enterprise data.

91. A health care information service layer comprising:
a message conversion rules memory for storing vendor specific rules for converting vendor specific message format to health care level format;
an automated interface gateway (AIG) catcher, said AIG catcher comprising a logical port for receiving vendor specific messages, a logical communications port for communicating, a logical memory connection for operationally connecting to the message conversion rules memory and executable logic for opening a vendor specific message generated by a vendor specific application running on a remote system, extracting information contained in a vendor specific message, identifying a remote system based on information in a vendor specific message, communicating with said message conversion rules memory via said logical memory connection and for retrieving vendor specific rules based on an identity of a remote system, converting information contained in a vendor specific message from vendor specific message format using vendor specific rules, and communicating converted health care level information via said logical communications port;
an health care level memory for storing health care level relationship rules and for storing health care level information;
an health care level server, said health care level server comprising a logical port for receiving health care system level messages, a logical memory connection for operationally connecting to the health care level memory and executable logic for opening a health care level message, extracting health care level information contained in a health care level message, communicating with said health care level memory via said logical memory connection and for retrieving health care level relationship rules, checking health care level information for a relationship with other health care level data based on the health care level relationship rules, scheduling health care level event based on a relationship between health care level information from a health care level message and health care level information from said health care level memory and communicating health care level messages via said logical communications port; and
a web server operationally connected to said enterprise server, said web server containing executable logic for receiving health care level messages, converting health care level messages to information packets of a mark up language and communicating information packets to a remote web client.

92. The health care information service layer recited above in claim 91 wherein said health care level memory further comprises:
a health care level privilege database containing privilege rules for accessing health care level information.

93. The health care information service layer recited above in claim 91 wherein said health care level memory further comprises:
a vendor database access database containing rules for accessing a remote system's vendor database.

94. The health care information service layer recited above in claim 91 wherein said health care level memory further comprises:
a health care level function containing an electronic signature tool.

95. The health care information service layer recited above in claim 91 wherein said health care level memory further comprises:
a health care level function containing an automatic faxing tool.

96. The health care information service layer recited above in claim 91 wherein said health care level memory further comprises:
a health care level function containing an notification tool for notifying health care level users of the occurrence of a health care level event.
